(19) United States
(12) Patent Application Publication
(10) Pub. No.: US 2014/0059237 A1
(43) Pub. Date: Feb. 27, 2014

(54) SCHEDULING AND CONDUCTING A COMMUNICATION SESSION WITH A REMOTE AGENT

(71) Applicant: Apple Inc., Cupertino, CA (US)

(72) Inventors: Raymond J. Pittman, San Francisco, CA (US); Debbie S. Siek, San Jose, CA (US); Jennifer Jo Bailey, Los Altos Hills, CA (US); Cathal Finnbar McCarthy, San Jose, CA (US); Daniel Abraham Leiva, San Jose, CA (US); Mahta Zareh Eghbali, San Francisco, CA (US); Nelson Apollo Lee, Campbell, CA (US); Andrew Saewon Kim, San Francisco, CA (US); Vander McClain, San Francisco, CA (US); Kirk Von Rohr, Atherton, CA (US)

(21) Appl. No.: 14/011,479

(22) Filed: Aug. 27, 2013

Related U.S. Application Data
(60) Provisional application No. 61/693,746, filed on Aug. 27, 2012.

(51) Int. Cl. H04L 29/06

(52) U.S. Cl. CPC H04L 65/1069
USPC 709/227

(57) ABSTRACT

Disclosed herein are systems, methods, and non-transitory computer-readable storage media for conducting and scheduling a communication session with a remote agent. A communication session can be scheduled using a scheduling interface configured to present scheduling data. Upon scheduling a communication session, the user can be sent a confirmation message including the details of the scheduled communication session. The user can enter the communication session via a launch page configured to allow entrance to the communication session during a scheduled time period. Prior to the time period, the launch page can present the user with a clock indicating the remaining time until the user can enter. Upon entering the communication session, the user is presented with a communication session interface enabled with a primary communication method. Communication methods can be added or terminated with terminating the communication session as long as one communication method remains active.

### CROSS REFERENCE TO RELATED APPLICATIONS

This application claims the benefit of U.S. provisional application number 61/693,746, entitled “SCHEDULING AND CONDUCTING A COMMUNICATION SESSION WITH A REMOTE AGENT”, filed on Aug. 27 2012, which is expressly incorporated by reference herein in its entirety.

### TECHNICAL FIELD

The present disclosure relates to communication sessions and more specifically to scheduling and conducting a communication session with a remote agent.

### INTRODUCTION

The internet has made information more accessible than ever. With an internet connection and a search engine, it is relatively easy to gather a great deal of information regarding any subject imaginable. Although the internet is a great source of information, finding answers to specific questions can still be time consuming. Further, the information obtained can be inconsistent from site to site and the credentials of the provider of the information may not be easily accessible. This makes it difficult to know what information to trust.

Traditionally, information regarding a subject would be obtained via an in person or face-to-face interaction with a specialist or expert in the subject. Such an interaction with a specialist provides the advantages of efficiently getting answers to specific questions of the user and being able to have some level of confidence in the information obtained. However, relying on such an interaction it is not as convenient as an internet search. In particular, there are difficulties related to scheduling an interaction with such a specialist. For example, the selection of the specialist is typically limited to those in close proximity to avoid extended travel. As a result, scheduling a time can be difficult. Thus, a need exists for a way to get answers to specific questions from a trustworthy source that can be done with the convenience and ease provided by the internet.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for scheduling and conducting a communication session with a remote agent. A communication session server can be configured to present a scheduling interface to a user which enables the user to schedule a communication session with a remote agent. The scheduling interface can be configured in multiple ways to enable a user to schedule a communication session. For example, the scheduling interface can be presented based on time, remote agents, user preferences, etc.

Upon scheduling a communication session, the user can be sent a confirmation message including the details of the scheduled communication session. The confirmation message can also contain a link to a launch page configured to enable a user to enter the communication session. The launch page can be configured to only allow a user to enter the communication session during a scheduled time period. Prior to the time period, the launch page can present the user with a clock counting the remaining time until the scheduled time begins. During the scheduled time, the launch page can present the user with a button enabling the user to enter the communication session.

Upon entering the communication session, the user is presented with a communication session interface enabled with a primary communication method. The user can add and remove communication methods without terminating the communication session as long as one communication method remains active. Communication methods include voice, chat, video, screen share, etc. Upon completion of the communication session, the user can be sent a summary message that summarizes the communication session and includes information (e.g., links) selected based upon the conducted communication session.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system embodiment of a general-purpose computing device;

FIG. 2 illustrates a system embodiment enabling a user to schedule and conduct a communication session with a remote agent;

FIGS. 3a-3d illustrate screenshots of exemplary embodiments of a scheduling interface;

FIG. 4 illustrates screenshot of a scheduling interface prompting a user to enter contact information;

FIG. 5 illustrates scheduling interface configured to authenticate a user;

FIG. 6 illustrates a scheduling interface presenting scheduling data specific to a user;

FIGS. 7a-7c illustrate screenshots of exemplary confirmation messages;

FIGS. 8a-8c illustrate screenshots of an exemplary launch page;

FIGS. 9a-9h illustrate screenshots of an exemplary communication session interface incorporating multiple communication methods;

FIG. 10 illustrates a country code selection box presenting multiple country options;

FIGS. 11a-11d illustrate a screenshot of a picture of a remote agent configured to present further information;

FIG. 12 illustrates an exemplary summary message;

FIG. 13 illustrates an exemplary system embodiment of scheduling a communication session;

FIG. 14 illustrates an exemplary embodiment of presenting a launch page to a communication session; and

FIG. 15 illustrates an exemplary embodiment of conducting a communication session.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

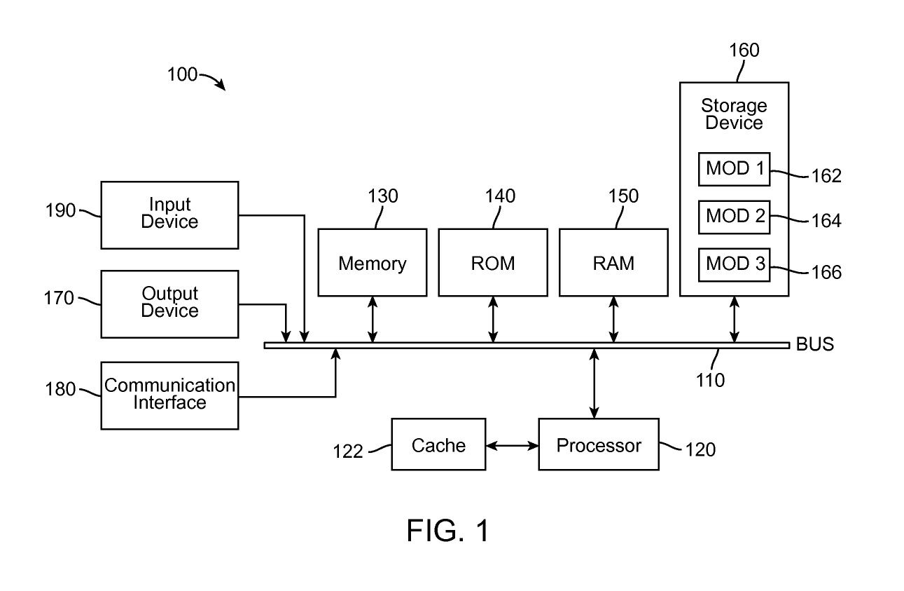

FIG. 1 illustrates an exemplary system 100 that includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example, the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

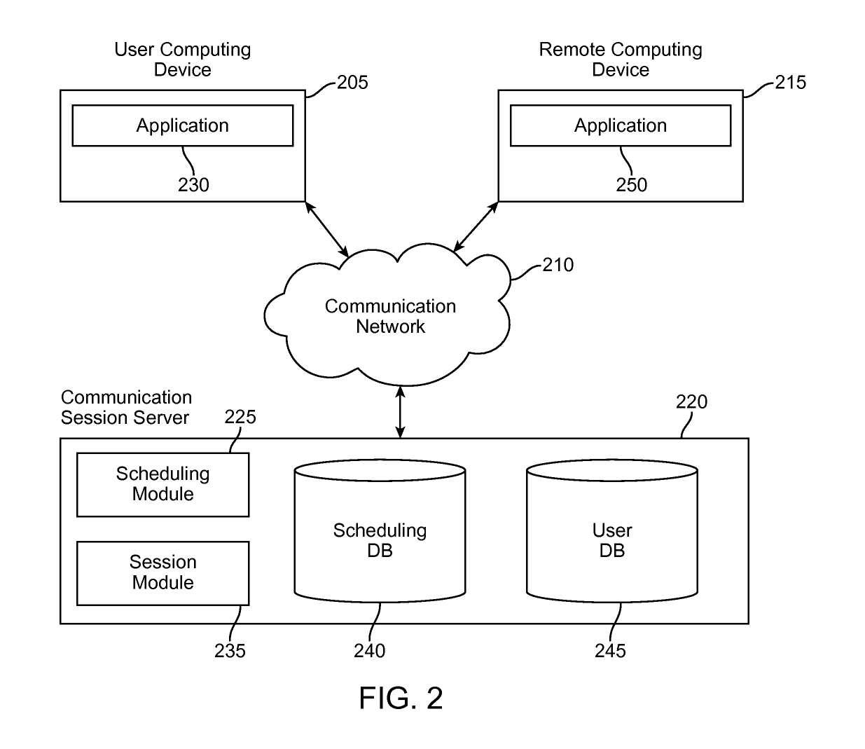

Having disclosed some components of a computing system, the disclosure now turns to FIG. 2, which illustrates an exemplary system embodiment in which multiple computing devices can be configured to communicate with each other to schedule and conduct a communication session with a remote agent. A communication session can be any type of communication with a remote agent that is at least partially conducted online using at least one of a variety of communication methods. A communication method can be any form of remote communication method such as chat, video, phone, voice, screen share, etc.

Further, a remote agent can be any type of person. For example, in some embodiments, the remote agent can be a support specialist and the disclosed system can be used to schedule and conduct a communication session with the support specialist. Other possible embodiments include a doctor, lawyer, professor, etc. These are just a few possibilities and are not meant to be limiting. One skilled in the art would recognize that the disclosed system can be used to schedule and conduct a communication session with any number of types of remote agent.

Returning to the discussion of FIG. 2, multiple computing devices can be connected to a communication network 210 and configured to communicate with each other through use of the communication network 210. The communication network 210 can be any type of network, including a local area network (“LAN”), such as an intranet, a wide area network (“WAN”), such as the internet, or any combination thereof. Further, the communication network 210 can be a public network, a private network, or a combination thereof. The communication network can also be implemented using any type or types of physical media, including wired communication paths and wireless communication paths associated with one or more service providers. Additionally, the communication network 210 can be configured to support the transmission of messages formatted using a variety of protocols.

Multiple computing devices can be connected to the communication network 210. A computing device can be any type of general computing device capable of network communication with other computing devices. For example, the computing device can be a personal computing device such as a desktop or workstation, a business server, or a portable computing device, such as a laptop, smart phone, or tablet personal computer. The computing device can include some or all of the features, components, and peripherals of computing device 100 of FIG. 1.

To facilitate communication with other computing devices, the computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

As illustrated, three computing devices; a user computing device 205, a remote computing device 215, and a communication session server 220, are each connected to a communication network 210 and configured to communicate with each other to schedule and conduct a communication session. The user computing device 205 can be configured to enable a user to access the communication session server 210 to schedule a communication session and conduct the communication session with a remote agent. The remote agent can conduct the communication session with the user of the user computing device 205 through use of the remote computing device 215.

To communicate with the communication sever 220, the user computing device 205 can include an application 230 that a user of the user computing device 205 can use to request and send data. For example, in some embodiments the application 230 can be a web browser application configured to request content from the communication session server 220 and render the requested content on the user computing device 205. The web browser application 230 can be further configured to transmit data to the communication session server 220.

In some embodiments, the application 230 can be a client application configured to access a network service and to allow a user to request data from and send data to the network service. For example, the client application 230 can be a communication session scheduling application configured to communicate with the communication session server 220 to request data and render the data on the user computing device 205 to schedule a communication session. The client application 230 can be further configured to transmit data to the communication session server 220 to schedule the communication session.

Using the application, the user computing device 205 can communicate with a scheduling module 225 associated with the communication session server 220 to schedule a communication session. The scheduling module 225 can be configured to present scheduling data and receive input from a user to schedule a communication session with a remote agent.

Scheduling data can include any data regarding the scheduling of the communication session. For example, scheduling data can include data regarding the remote agents with which a communication session can be scheduled. This can include biographical information about a remote agent such as background information, prior experience, area of expertise, interests, accreditations, education, current title, etc. Scheduling data can further include contact information for the remote agent such as a phone number, e-mail address, etc. The scheduling data can also include a picture of the remote agent.

In addition to information about a remote agent, the scheduling data can also include data regarding the availability of the remote agent. This can include what days and times the remote agent is available to conduct a communication session, what times a remote agent is currently scheduled to conduct a communication session, etc.

Scheduling data can be stored in a scheduling database 240 associated with communication session server 220 and configured to store communication data. The scheduling module 225 can be configured to communicate with the scheduling database 240 to search the scheduling data and retrieve scheduling data to present to the user. The scheduling module 225 can also be configured to communicate with the scheduling database 240 to enter new scheduling data or modify scheduling data stored therein.

In addition to the general scheduling data discussed above, scheduling data can also include scheduling data that is specific to a user. Such data can be stored in a user database 245 associated with the communication session server 220. For example, scheduling data can include data about previous communication sessions that the user has conducted with a remote agent. This can include the date and time of the previous communication sessions, the topic of the previous communication session, the remote agent with which the previous communication session was conducted, etc.

Scheduling data specific to a user can also include data about an upcoming communication session that the user has already scheduled. For example, the scheduling data can include the date and time of the upcoming communication session, the topic of the upcoming communication session, the remote agent with which the upcoming communication session is scheduled, etc.

To present scheduling data specific to a user, the scheduling module 225 can be configured to present the user with a login prompt enabling the user to enter a user name and password. The scheduling module 225 can be configured to authenticate the entered login information against user profile records stored in the user database 245. If the entered user name and password match a record in the user database 245, the identity of the user can be authenticated and scheduling data specific to the user can be accessed and presented.

In some embodiments, the scheduling data specific to the user can be stored in the user database 245 and associated with the user profile of the user. In some embodiments, the scheduling data specific to the user can be stored in the scheduling database 240 and a user ID associated with the authenticated user can be used to access the appropriate data in the scheduling database 240.

The scheduling module 225 can be configured to present the scheduling data in a scheduling interface delivered to the user computing device 205. The scheduling interface can be presented via application 230 or another application at user computing device 205. The scheduling interface can be configured to enable a user to schedule a communication session. This can be achieved in numerous ways. In some embodiments, the user can be presented with a scheduling interface that presents available times to schedule the communication session. For example, the scheduling interface can include an interactive calendar enabling the user to select a time to schedule the communication session.

In some embodiments, the scheduling interface can be configured to present the user with a selection of remote agents with which a communication session can be scheduled. For example, the user can be presented with a list of remote agents that includes information about each remote agent. The user can thus use the provided information to select a remote agent with which to schedule a communication session. In some embodiments, the scheduling interface can present the remote agents in groups or categories. For example, the remote agents can be grouped based upon specialty, availability, background, etc.

In some embodiments, the scheduling interface user can present the user with questions or options that can aid the user in selecting a remote agent. The scheduling module 235 can then be configured to filter the available remote agents based upon the user responses entered to the questions. For example, the user can be prompted to select a topic of the communication session, a preferred time, etc. Based on the user's selections, the scheduling module can be configured to select remote agents that are best suited for the user. This can be determined based upon the scheduling data regarding each remote agent. The scheduling interface can then present only the remote agents that meet the user's entered criteria.

In some embodiments, the scheduling interface can incorporate a combination of the above discussed methods. For example, a user can first be presented with questions to determine user preferences, followed by a calendar to select a preferred communication session time, followed by a listing of available remote agents including information about each remote agent.

In some embodiments, the scheduling interface can present the scheduling data presented to a user based upon the user's previous selection. For example, in a scenario where a user is first prompted to enter user preferences followed by a calendar to select a communication session time, the user's entered preferences can be used to filter the available times presented in the calendar interface. The scheduling module 225 can be configured to search the scheduling data in scheduling database 240 to determine remote agents that match the user's entered preferences and then only present time slots in which at least one of the remote agents is available to schedule a communication session. Thus, the user will only be presented with time slots in which a communication session can be scheduled with a remote agent meeting the user's indicated preferences. If in this scenario the user is next presented with a selection of remote agents, the scheduling module 225 can be configured to filter remote agents to present based on the user's selection of time slot. Thus the scheduling module 225 will only present the user with remote agents that are available to schedule a communication session in the time slot selected by the user and that meet the user's entered preferences.

The scheduling interface can be configured to receive user input in any number of ways. For example, the scheduling interface can be configured to include user interface elements such as buttons, links, checkboxes, text fields, etc., configured to receive a user's selection. The user can make selections through use of the user interface elements presented at the user computing device 205. The selection and arrangement of such interface elements can be pre-defined. However, the present disclosure contemplates that the selection and arrangement of such interface elements can occur dynamically. For example, the interface elements and arrangement thereof can vary depending on properties or characteristics of user computing device 205.

Upon a user scheduling a communication session using the scheduling interface, the scheduling module 225 can be configured to update the scheduling data in the scheduling database 240 to indicate that the communication session has been scheduled. This can include recording that the selected remote agent is scheduled to conduct a communication session with the user and updating the scheduling data reflecting the availability of the remote agent.

The scheduling module 225 can also update scheduling information specific to the user in user database 245, such as any contact information gathered from the user and any preferences selected by the user while scheduling the communication session. For example, in some embodiments, the scheduling interface can prompt a user to enter contact information prior to completing the scheduling of the communication session and the contact information can be stored by the scheduling module 225 in user database 245.

The scheduling module 225 can also be configured to send a confirmation message to the user upon a communication session being scheduled. Such a confirmation can be delivered to user computing device 205, another device associated with the user, or any combination thereof. Further, the confirmation message can be any type of message such as an e-mail, automated phone call, or text message, to name a few. However, the various embodiments are not limited in this regard and the present disclosure contemplates that any other type of communications device or message type can be used in the various embodiments.

In some embodiments, the confirmation message can include the details of the scheduled communication session including the time, date, topic, remote agent, etc. The confirmation message can also be configured to enable a user to reschedule or cancel the scheduled confirmation message. For example, the confirmation message can include a user interface element such as a button or link that can forward the user to a scheduling interface configured to enable a user to cancel or reschedule the communication session. In some embodiments, the confirmation message can include a scheduling interface enabled to cancel or reschedule the communication session directly from the confirmation message.

In some embodiments, the confirmation message can also include a user interface element configured to connect the user to a communication session. For example, the confirmation message can include a user interface element such as a button or link that, when selected, forwards the user to a launch page configured to allow access to the communication session. In some embodiments, the launch page can be included in the confirmation message and the user can access the communication session from the confirmation message.

The launch page can be an interface configured to enable the user to enter the communication at a scheduled time. For example, the launch page can be configured to monitor the time remaining and only provide a button enabling the user to enter the communication session during a specified time frame. For example, the launch page can be configured to enable a user to enter the communication session for a ten minute window of time beginning at the scheduled communication session time. In some embodiments, the launch page can provide a countdown to the scheduled time notifying the user as to how much time is remaining before the user can enter the communication session.

In addition to sending a confirmation message to the user, the scheduling module 225 can also be configured to send a confirmation message to the remote agent at remote computing device 205 or any other device associated with the remote agent. The confirmation message can include scheduling data regarding the scheduled communication session such as the time, date, topic, user, user contact information, user entered notes, etc. In some embodiments, the scheduling module 225 can use stored contact information for a remote agent to send a confirmation message to the agent.

The scheduling module 225 can also be configured to send a confirmation message upon a communication session being canceled or rescheduled.

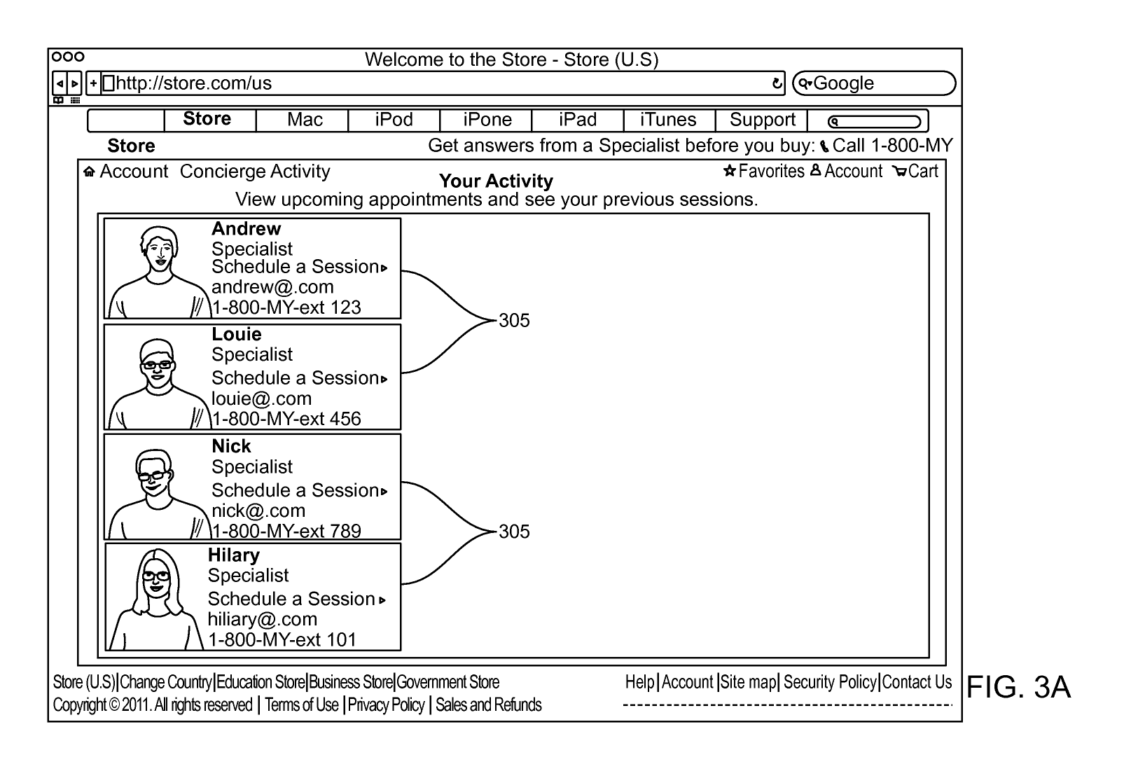

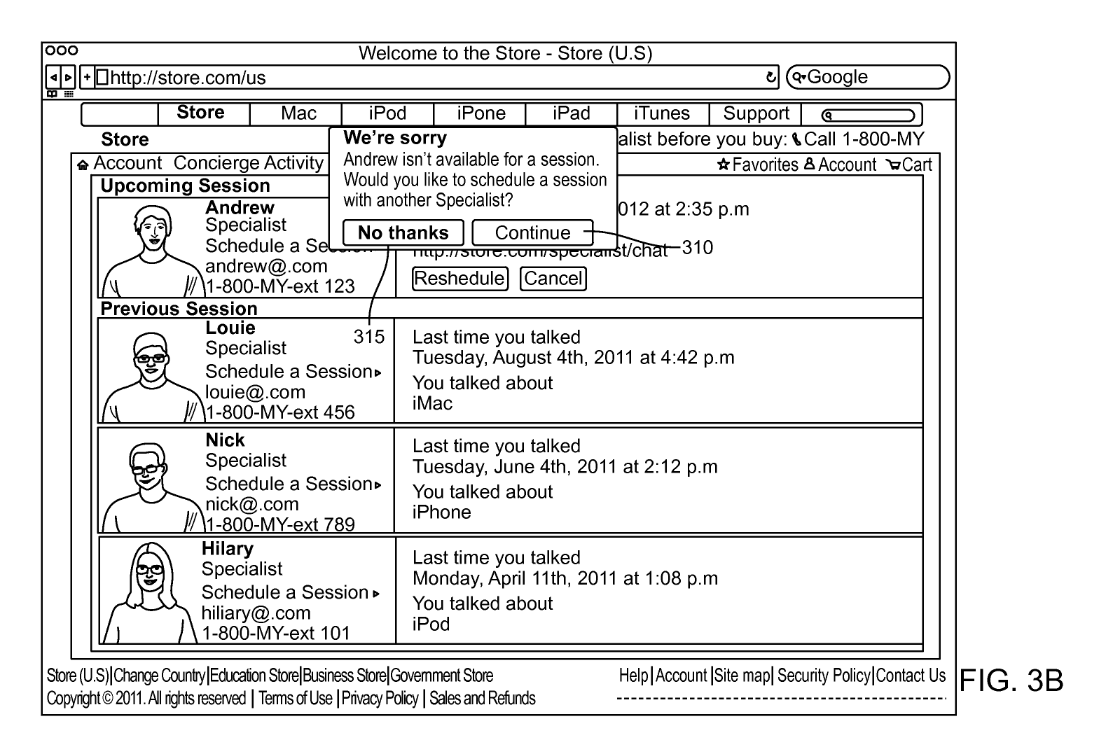

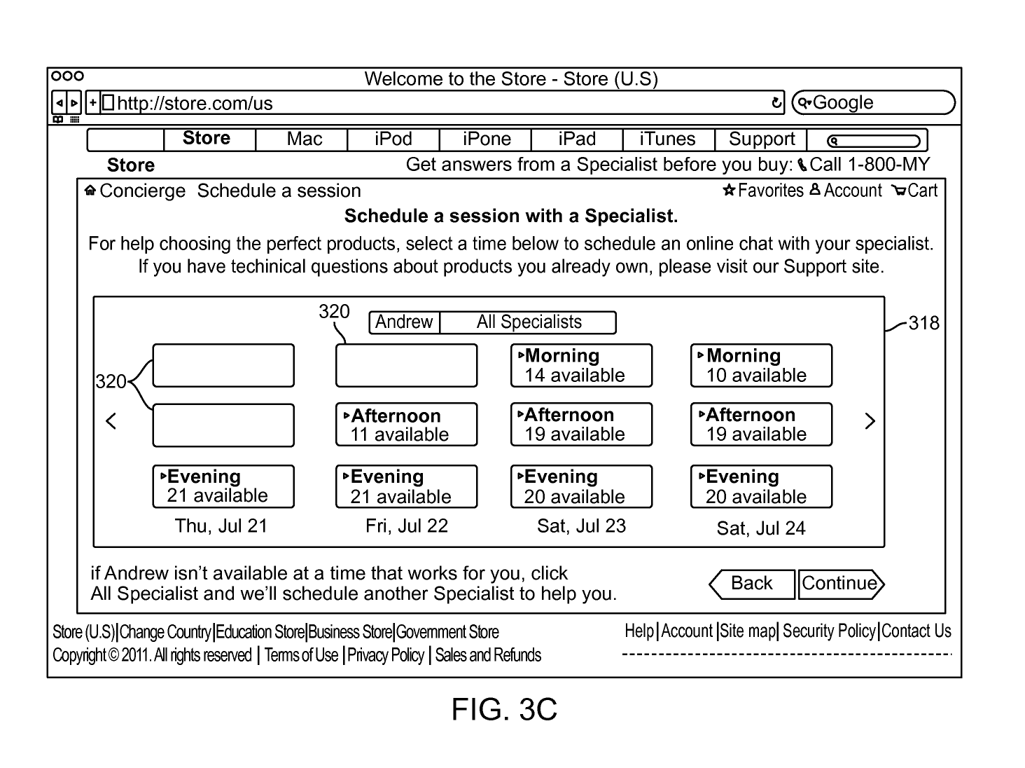

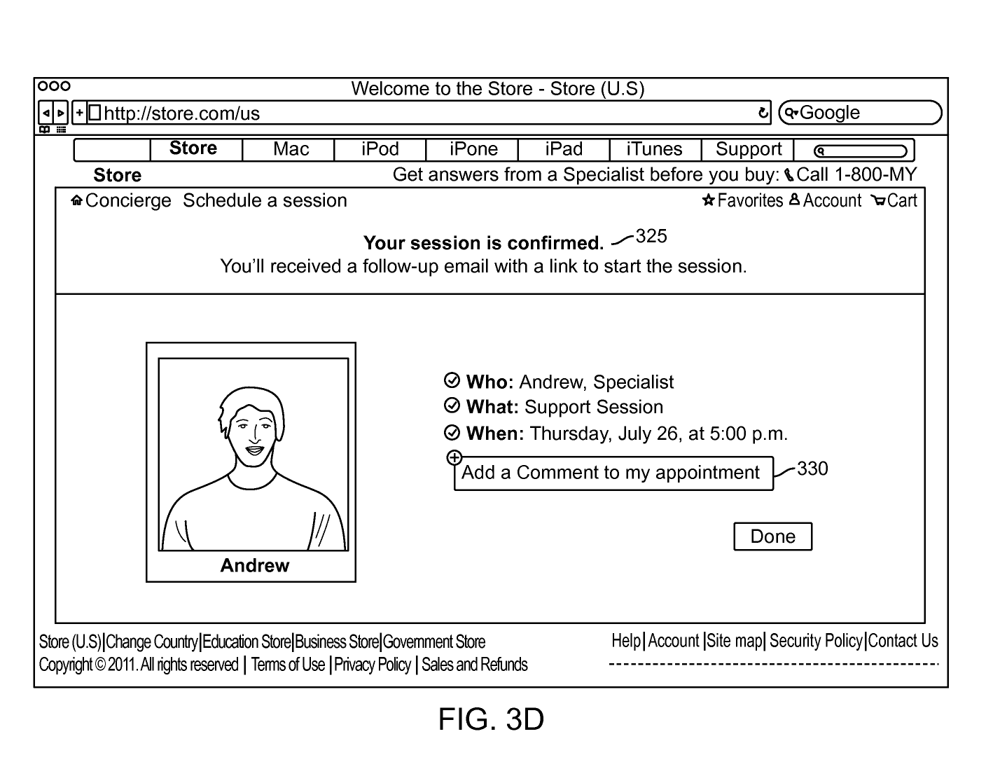

FIGS. 3a-3d illustrate screenshots of an exemplary embodiment of a scheduling interface. As illustrated in FIG. 3a, a scheduling interface listing multiple remote agents is presented. Information about each remote agent is presented in a box mimicking a business card 305. As illustrated, each business card 305 includes personal information about the respective remote agent, including a photograph, title and contact information, both email and telephone number, for the respective agent.

In some embodiments, the contact information can be active links enabling a user to directly contact the agent via the listed contact information. For example, selecting the e-mail address of the remote agent can create an e-mail addressed to the respective remote agent. Similarly, selecting the phone number can initiate a phone call to the presented number, for example, in embodiments in which the user computing device 205 is a smart phone.

In addition to the information regarding each agent, the business card 305 for each remote agent can also include a user interface element enabling a user to schedule a communication session with the respective remote agent. As illustrated, each business card includes a link prompting a user to schedule a communication session with the respective remote agent.

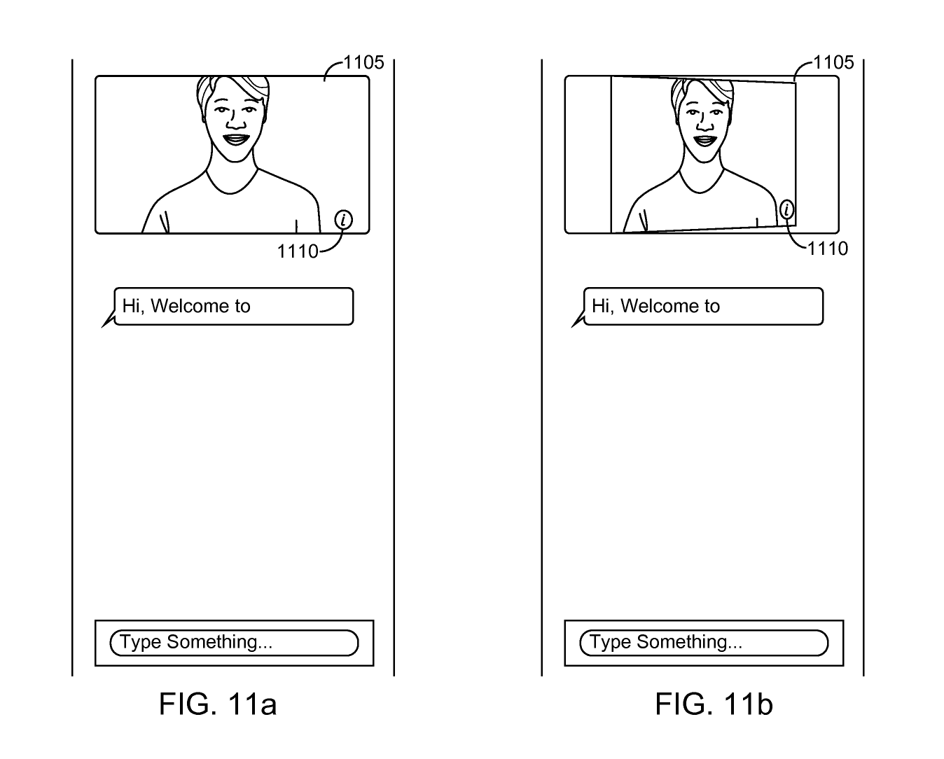

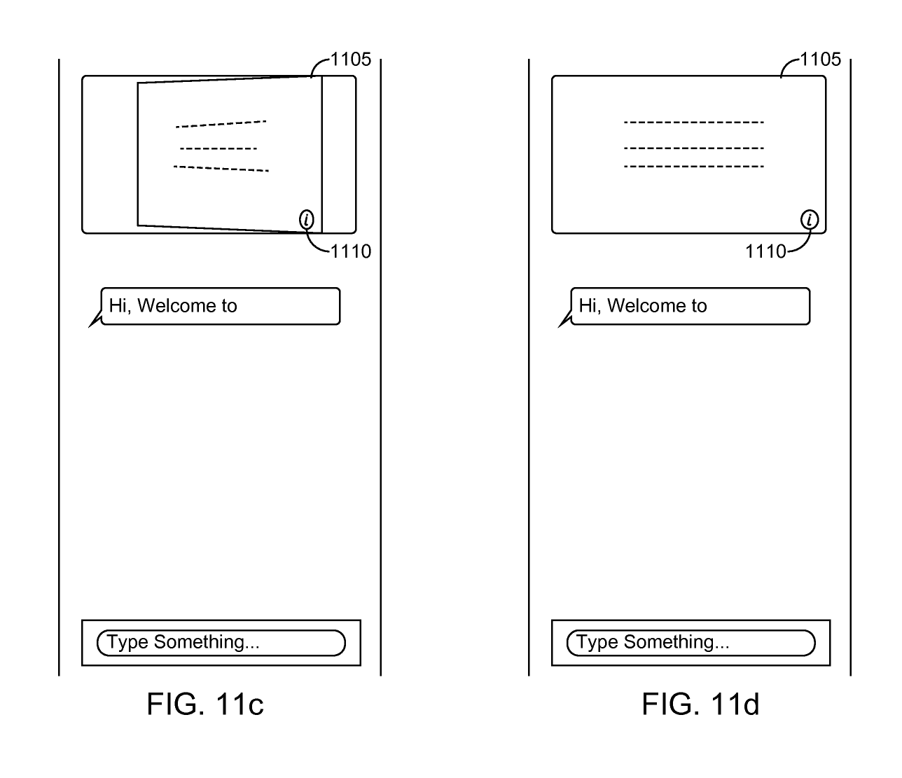

In some embodiments, the business card for each remote agent can be configured to present further information regarding the remote agent upon selection. For example, the business card can be configured to include a button that, when selected, causes the business card to display further information about the remote agent such as a short biography, interests, previous experience, etc. In some embodiments, the business card can be configured to rotate to reveal the additional information on the back of the business cards. The business card can be configured to rotate back to the front upon a user interaction such as pressing a button. This concept is illustrated in FIGS. 11a-11d and described further below.

FIG. 3b illustrates a screenshot of an exemplary message presented in response to a user selecting the user interface element to schedule a communication session. In this embodiment, the selected remote agent is not available to schedule a communication session and thus the user has been sent a message indicating that the remote agent is not available. As illustrated, the message asks the user if he/she would like to schedule a communication session with a different remote agent. The message also includes two user interface elements to receive input from the user. As illustrated, the two user interface elements are buttons. One of the buttons 310 is configured to enable the user to schedule a communication session with a different remote agent. Upon selection of this button 310, the user can be returned to a scheduling interface screen similar to the one illustrated in FIG. 3a. The other button 315 indicates that the user does not want to schedule a communication session with a different remote agent and can be configured to direct the user to content unrelated with scheduling a communication session. Upon selecting button 310 and being forwarded to a scheduling interface, the user does not need to be limited to scheduling a communication session with a different remote agent. In some embodiments, the user can schedule an appointment with the same agent at a different time. In some embodiments, the user can be presented with a calendar interface or prompted to refine criteria to schedule a communication session.

In some embodiments, the calendar can indicate communication sessions open to multiple users. For example, the communication session can be a class or lecture open to multiple users. In this type of embodiment, the communication session can be open to the public and any user can join or schedule to join. In some embodiments, the communication session can be a closed class or lecture. For example, a communication session can be scheduled that includes multiple users; however a password or authentication is required to join or schedule. In some embodiments, a communication session can be scheduled with multiple remote agents at the same time.

FIG. 3c illustrates an embodiment in which scheduling interface presents the user with an interactive calendar 318 with various segments. As illustrated, calendar 318 shows that each day is broken up into three segments: morning, afternoon and evening. In other embodiments, more or less segments can be provided for any day. Each of segments can indicate how many communication sessions are available within the segment. In some embodiments, each remote agent can be available to conduct multiple communication sessions in a given time segment. For example, the morning segment may represent the hours from 8 am-12 pm and a remote agent may be available for 4 separate 1 hour communication sessions within that time period.

As illustrated, three of the segments 320 are presented as dark, shaded, or grey-out manner without any information. These three of segments 320 can be presented in this dark manner to indicate that there are no available communication sessions to be scheduled within the corresponding time frame. Alternatively, other indicia can be utilized to indicate segments with no communication sessions. In some embodiments, any of segments 320 that are dark can be inactive and thus cannot be selected by the user.

A user can select one of the active segments to schedule a communication session within the given time frame. In some embodiments, selecting a segment results in a communication session being scheduled for the user within the selected time frame, including a remote agent being selected for the user. In some embodiments, selecting a segment can direct the user to another scheduling interface screen where the user can select from the remote agents available to schedule a communication session within the selected time frame. For example, a user can be forwarded to a scheduling interface similar to the one illustrated in FIG. 3a.

FIG. 3d illustrates a screenshot of an exemplary confirmation page presented to a user after a communication session has been scheduled. As illustrated, the confirmation includes a message that the communication session has been confirmed 325 as well as scheduling data regarding the scheduled communication session. This includes a picture of the remote agent, the remote agent's name and title, the type of communication session and the date and time of the communication session. Further, the confirmation page includes a text box enabling a user to enter any comments that the user would like to send to the remote agent to review prior to the communication session. The entered comments can be sent to the remote agent as a part of a confirmation message sent to the remote agent.

Although FIGS. 3A-3D illustrate the inclusion of particular interface elements and particular arrangements thereof, the various embodiments are not limited in this regard and various other configurations can be provided.

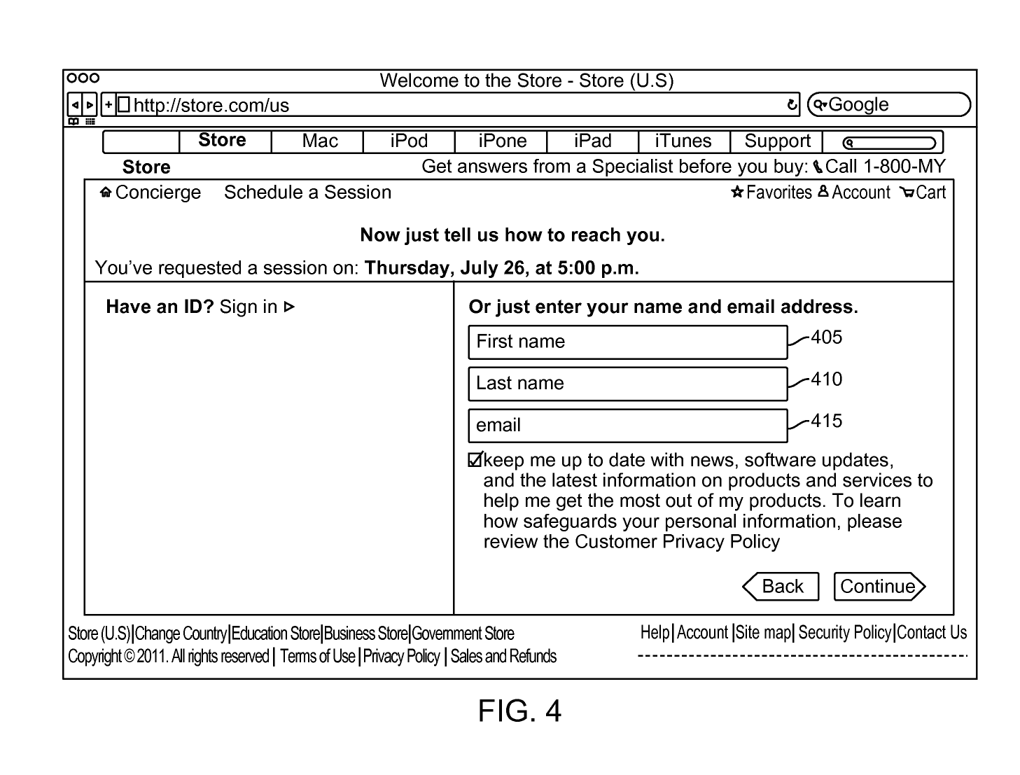

FIG. 4 illustrates a screenshot of an exemplary embodiment of a scheduling interface in which a user is prompted to enter contact information prior to completion of the scheduling of a communication session. As illustrated in FIG. 4, the user is prompted to enter their first 405 and last name 410 as well as their e-mail address 315 into provided text boxes. The entered information can be stored and used to contact the user. For example, the e-mail address can be used to send the user a confirmation message after the user has completed scheduling a communication session with a remote agent. In addition, any other type of contact information can be requested.

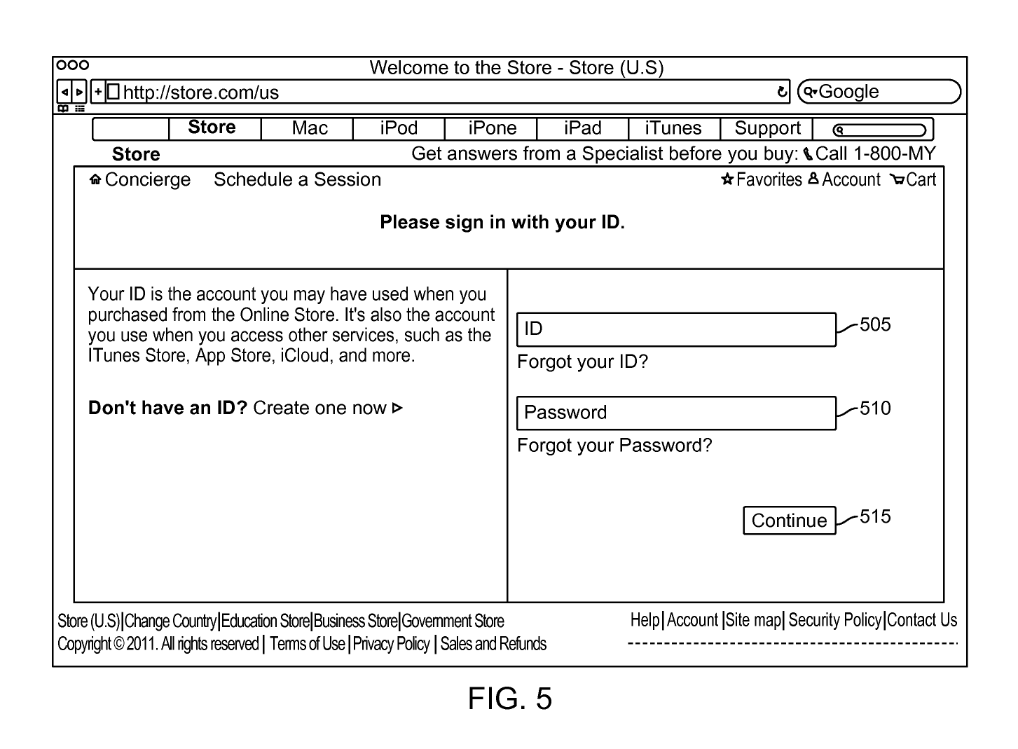

FIG. 5 illustrates a screenshot of an exemplary scheduling interface to authenticate a user. As illustrated, a user can be prompted to enter their user name 505 and password 510 into provided text boxes. The interface can also include a button 515 which, when selected, submits the entered user name 505 and password 510 so that it can be authenticated against stored user profile data. If the entered user name 505 and password 510 match stored records, the user can be authenticated and presented with scheduling data specific to the user.

FIG. 6 illustrates a screenshot of a scheduling interface in which a user is presented with scheduling data specific to the user. As illustrated, the user is presented with scheduling data regarding previously conducted communication sessions 605 as well as upcoming communication sessions 610. Each of the previous communication sessions 605 listed includes scheduling data about the remote agent with which the communication session was conducted. This information is presented in a business card format similar to the one described in FIG. 3a. Further, the time and date of each previous session is listed as well as the topic of the previous session.

The scheduling interface presents the upcoming communication session 610 in a similar manner. As illustrated, scheduling information regarding the remote agent with which the communication session is scheduled is presented in a business card format similar to the ones presented for the previous communication sessions. Further, the time and date of the upcoming communication session is also presented. The interface also includes a link 615 to initiate the communication session. This link 615 can be configured to forward the user to a launch page or, alternatively, it can be configured to enter the user into the communication session upon its selection. The interface also includes two buttons, one enabling a user to reschedule the communication session 620 and one enabling a user to cancel 625 the communication session.

In some embodiments, the scheduling interface can be configured to rotate to present further information on the back of the scheduling interface. For example, the scheduling interface can include a user interface element configured to enable the user to rotate the scheduling interface. This concept is described in further detail in FIGS. 11a-11d. In some embodiments, the opposite side of the scheduling interface can include a scheduling interface presenting general scheduling data such as that illustrated in FIGS. 3a and 3c.

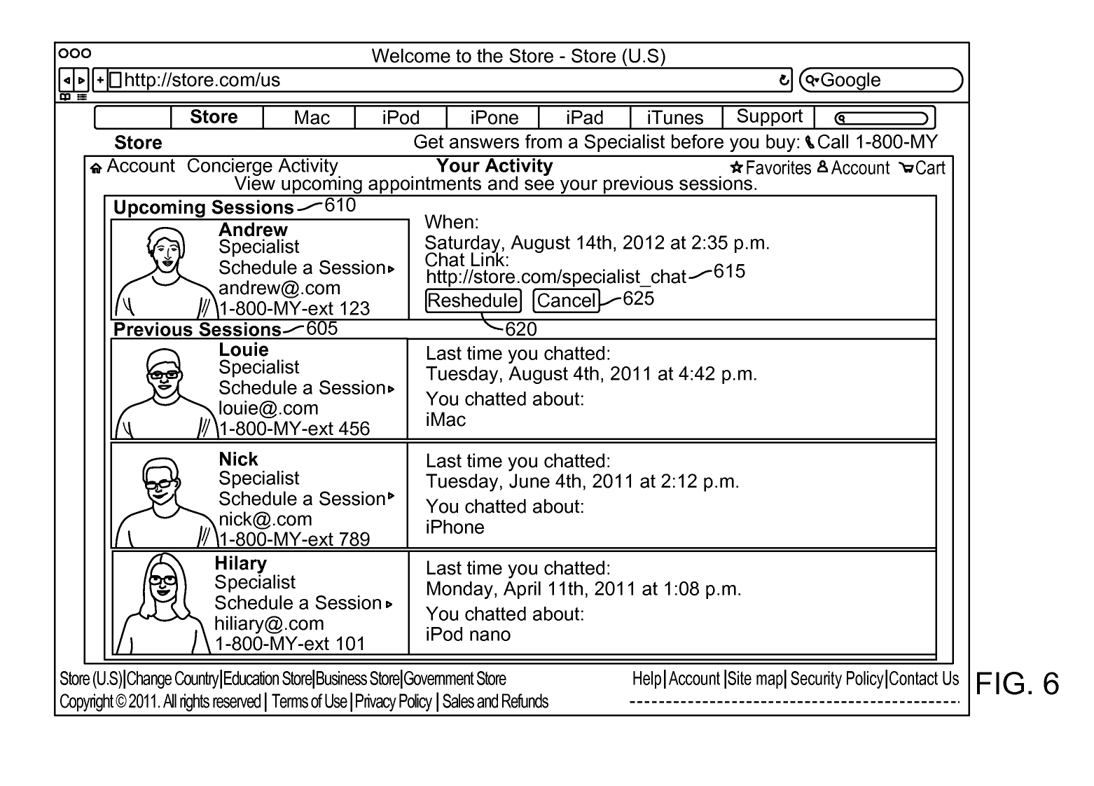

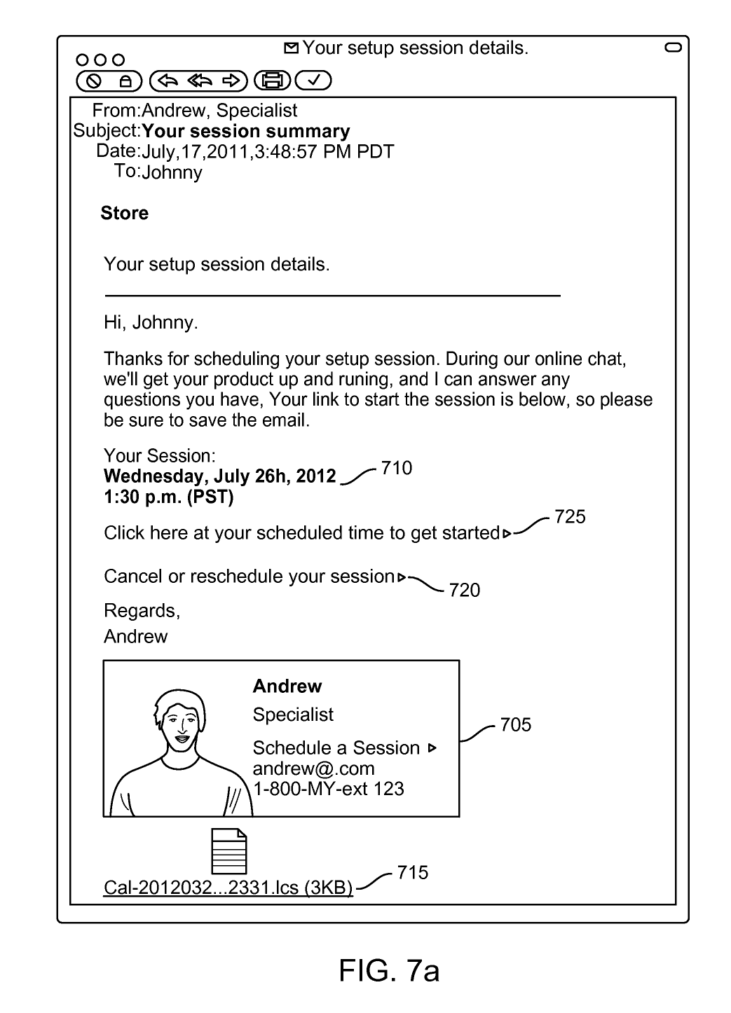

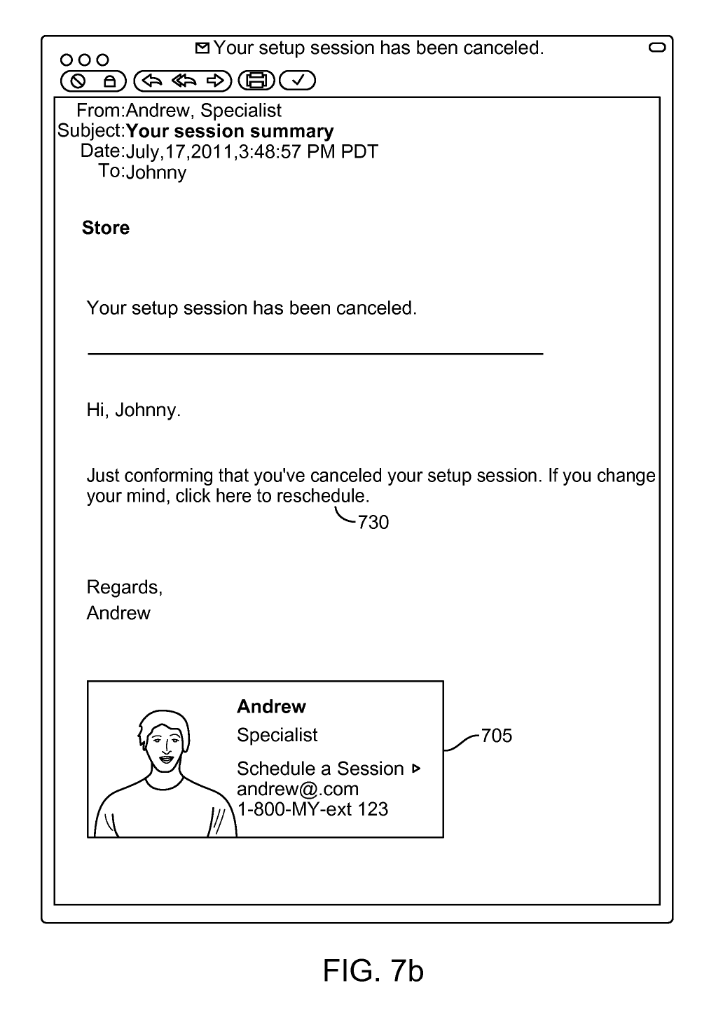

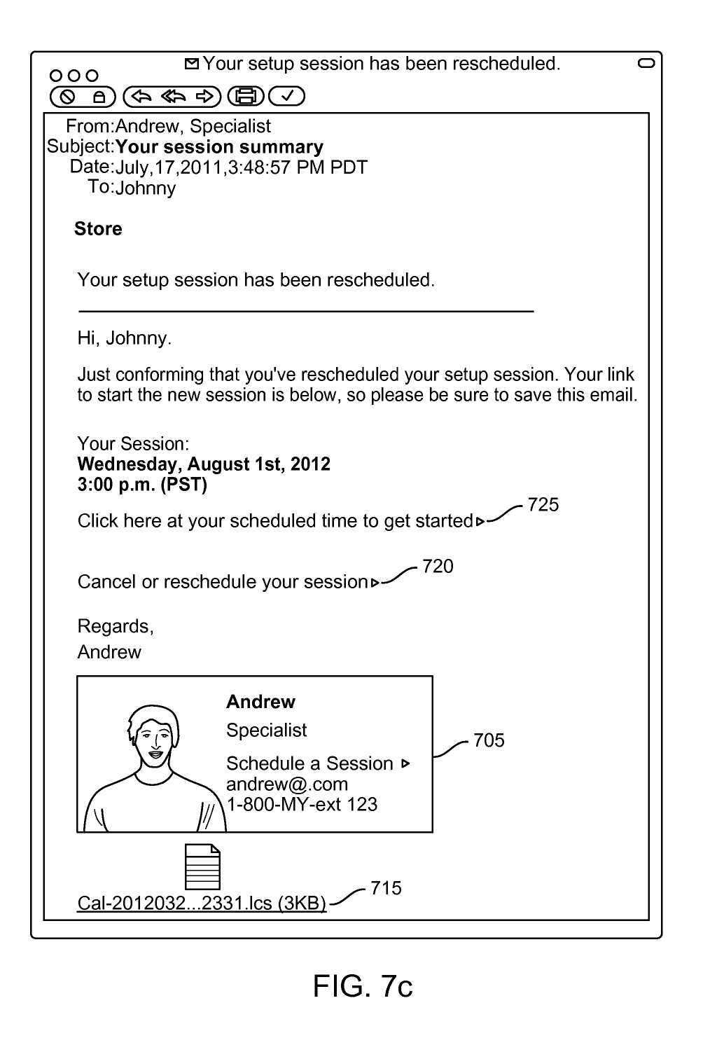

FIGS. 7a-7c illustrate screenshots of exemplary confirmation messages for a user based on scheduling a communication session. FIG. 7a illustrates a confirmation message sent in response to a user scheduling a communication session. As illustrated, the confirmation session is an e-mail addressed to the user that indicates that a communication session has been scheduled and includes the details of the scheduled communication session. This includes business card 705 displaying information regarding the remote agent, including a picture, title, and contact information. The business card 705 also includes a link enabling a user to schedule another communication session with the user. The confirmation message also includes the date and time 710 of the communication session.

The confirmation message also includes a calendar reminder attachment 715. This attachment 715 can be configured to communicate with a calendar application on the user computing device to enter the details of the communication session. Thus, the user can enter the communication session into their calendar by simply clicking the attachment 715.

The confirmation message also includes a link 720 enabling a user to cancel or reschedule the scheduled communication session. The link 720 can be configured to direct the user to a scheduling interface enabling the user to cancel the communication session or select a new time or remote agent for the communication session. The confirmation message also includes a link 725 to enable a user to enter the communication session. This link 725 can forward the user to ta launch page or enter the communication session.

FIG. 7b illustrates a screenshot of an exemplary confirmation message sent in response to a communication session having been canceled. As illustrated, the confirmation message indicates that the communication session has been canceled. The confirmation message further includes a link 730 enabling a user to reschedule the communication session. The confirmation message further includes a business card 705 displaying information about the remote agent with which the canceled communication session was scheduled. In some embodiments, the confirmation message can further prompt the user to reschedule the communication session and include a link to a scheduling interface. In some embodiments, the confirmation message can prompt a user to confirm that the user actually intended to cancel the communication session. The confirmation message can include a link to a scheduling interface enabling the user to confirm the cancelation or indicate that it is in error. Alternatively, the confirmation message can include buttons enabling a user to confirm the cancellation or indicate that the cancelation is in error.

FIG. 7c illustrates a screenshot of an exemplary confirmation message indicating that a communication session has been rescheduled. As illustrated, the confirmation message indicates that the communication session has been rescheduled and includes details such as the date and time of the communication session as well as a business card 705 of the remote agent with which the communication session is scheduled. Further, the confirmation message includes a link 720 to cancel or reschedule the communication session as well as link to enter the communication session 725. Finally, the confirmation message also includes a calendar reminder attachment 715.

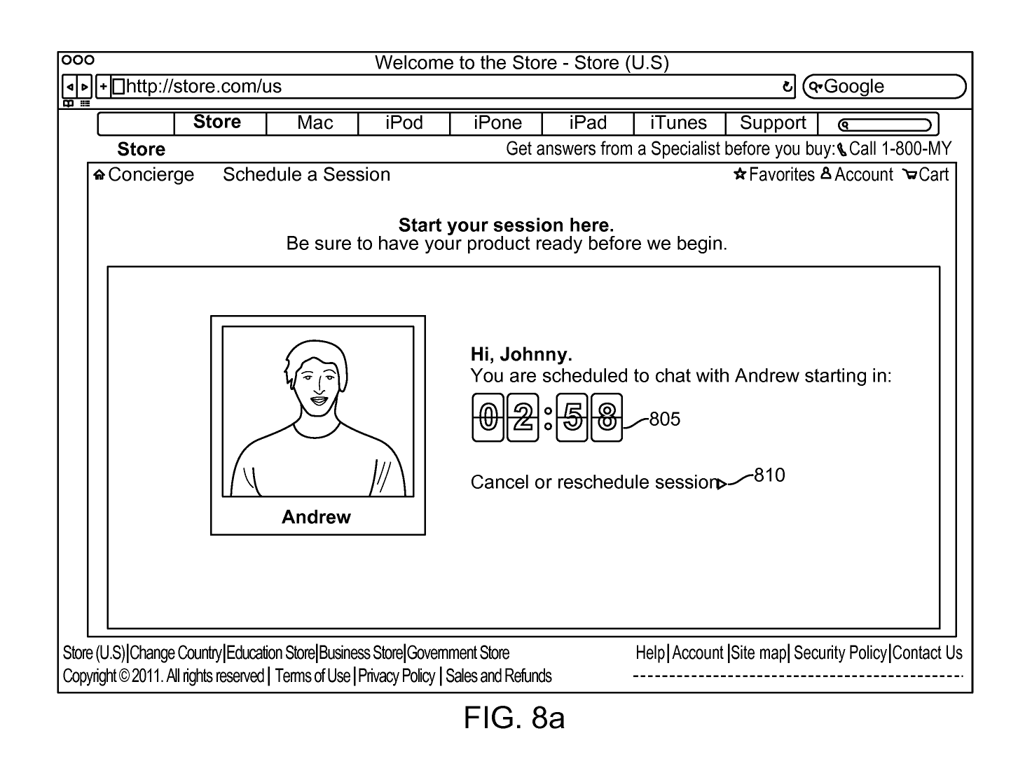

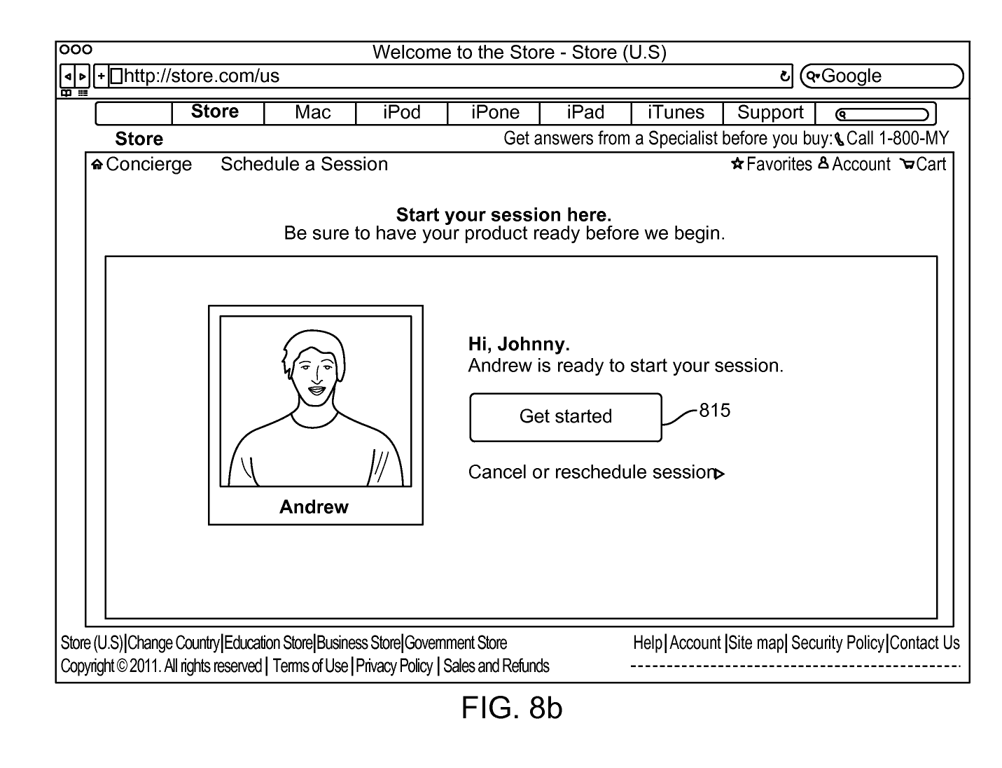

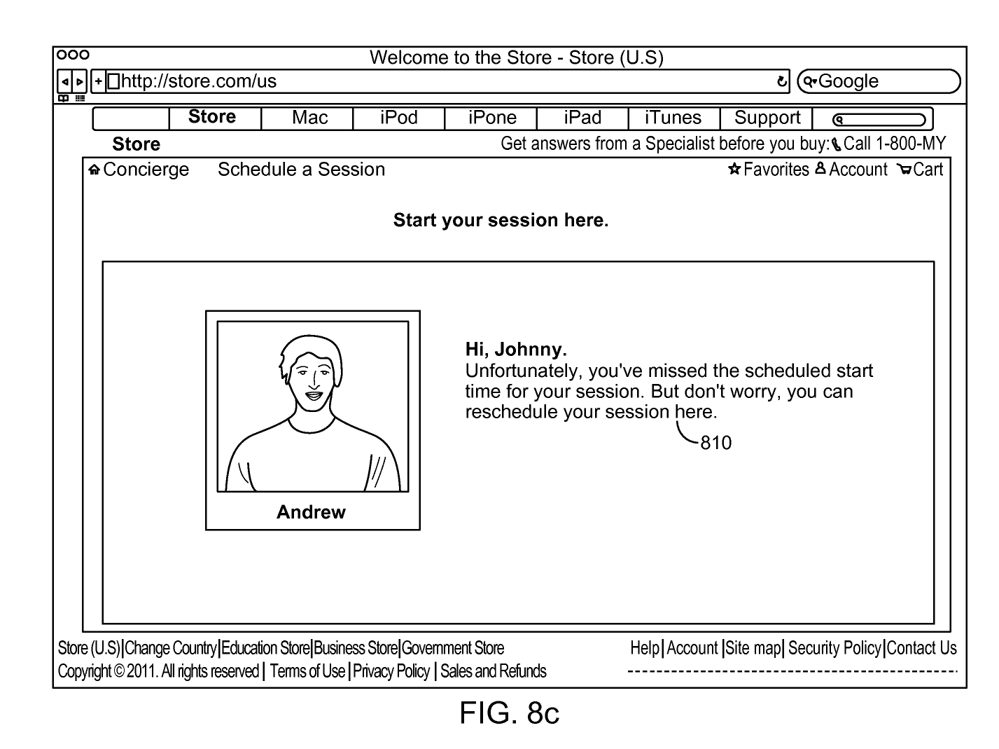

FIGS. 8a-8c illustrate screenshots of an exemplary launch page for a communications session. FIG. 8a illustrates a launch page prior to the scheduled time of the communication session. As illustrated, the launch page indicates that the user is scheduled to begin a communication session and includes a countdown 805 of the amount of remaining time before the communications session begins. Further the launch page includes a picture of the remote agent with which the communication session is scheduled as well as a link 810 to reschedule or cancel the communication session. The countdown 805 of the amount of remaining time can be configured to change in real time to keep the user updated to the exact amount of time remaining until the user can enter the communication session. It should be noted that the launch page does not include a button enabling the user to enter the communication session because in this embodiment the time frame within which the user can enter the communication session has not yet begun.

FIG. 8b illustrates a launch page during the time frame within which a user can enter the communication session. As illustrated, the launch page remains mostly the same as the launch page illustrated in FIG. 8a, however the launch page now indicates that the remote agent is ready to start the communication session and the countdown 805 has been replaced with a button 815 enabling the user to enter the communication session.

FIG. 8c illustrates a launch page after the time frame in which the user can enter the communication session. As illustrated, a message is displayed notifying the user that the user has missed the schedule time of the communication session and that the user can reschedule the communication session. The launch page further includes a link 810 enabling a user to reschedule the communication session. The link 810 can forward the user to a scheduling interface.

Returning to the discussion of FIG. 2, the communication session server 220 can also include a session module 235 configured to communicate with the user computing device 205 and the remote computing device 215 to conduct a communication session. Upon initiating a communication session, the session module 235 can be configured to provide a communication session interface in which the user and remote agent can send and receive data. For example, the communication session interface can be configured to receive text, video, audio, etc., from either the user or the remote agent and transmit it to the other party. A user and remote agent can thus conduct a chat communication, video communication, sound communication, etc. from their respective computing devices.

In some embodiments, the communication session interface enables the remote computing device 215 and the user computing device 205 to communicate directly. In some embodiments, the communication session interface enables the remote computing device 215 and the user computing device 205 to communicate using the communication session server 220 as an intermediary that receives communications from each and transmits it to the other.

The user can access the communication session interface using an application 230 such as a web browser application or client application on the user computing device 205. Likewise, the remote agent can access the communication session interface using an application 250 such as a web browser application or client application on the remote computing device 215.

The session module 235 can be configured to provide the communication session interface in multiple ways. For example, in some embodiments, the session module interface can be configured to begin the communication session with an initial communication method and allow the user and the remote party to add further communication methods during the communication session. A communication method can be any of numerous communication forms used to conduct a communication session. For example, communication methods can include phone, voice, chat, video, screen share, etc.

The session module 235 can thus be configured to initiate a communication session interface initially enabling one of these communication methods and allow for other communication methods to be added during the communication session. For example, in some embodiments the communication session interface can initially include a text box and chat display area enabling the user and the remote agent to communicate via inputted text in the text area. The communication session interface can further include user interface elements configured to add other communication methods such as video, phone, etc.

In addition to adding further communication methods, the communication session interface can also be configured to enable the termination of an active communication method. An active communication method can be communication method that is enabled in the communication session. For example, a communication session interface enabling both chat and video can be configured to allow a user to terminate one of the communication methods without affecting the other. Thus the communication methods used during the communication session can be changed without terminating the communication session itself as long as one communication method remains active.

In some embodiments, the communication session interface can be configured to present a singular window to manage all the communication methods. In some embodiments, the communication session interface can be configured to present multiple windows to manage the different communication methods. For example, the communication session interface can be configured to provide one window to manage communication with the remote agent (i.e. video, chat, phone.), and a second window to manage communication with a computing device of the remote agent (i.e. screen share).

To provide phone communication between the user and the remote agent, the communication session interface can be configured to prompt a user to enter their telephone number. Upon receiving the telephone number, the session module 235 can be configured to initiate a phone call with the remote agent and the user. The session module 235 can be configured to connect the two parties upon both answering the call. Further, the session module 235 can determine that a phone communication has been initiated.

To provide a screen share communication, in some embodiments, the remote computing device can be configured to transmit the screen displayed on the remote computing device directly to the communication session interface. In some embodiments, the remote computing device 215 can be connected to a secondary computing device (not illustrated) such as a tablet or smart phone, and the display of the secondary computing device can be transmitted to the communication session interface. In some embodiments, the screen share can include an overhead view that depicts the remote agent physically controlling the computing device. For example, a screen share communication of a tablet PC can be displayed in an overhead view to show the physical commands made as well as the screen of the tablet PC.

Upon completion of a communication session, the session module 235 can be configured to assemble and send a summary message to the user. The summary message can include a summary of the completed communication session as well as links to relevant information. The included links can be selected from a plurality of available links based upon a determination by the session module 235 that the links are relevant to the completed communication session. In some embodiments, the session module 235 can be configured to select the links based upon a chosen topic of the communication session as indicated by the user. In some embodiments, the session module 235 can be configured to select the links based upon input received from the remote agent. In some embodiments, the session module 235 can be configured to select the links based upon data gathered during the communication session. For example, the session module 235 can be configured to monitor entered text for keywords indicating a relevant topic of the communication session. The session module 235 can then select links that are associated to the relevant topic determined from the key words.

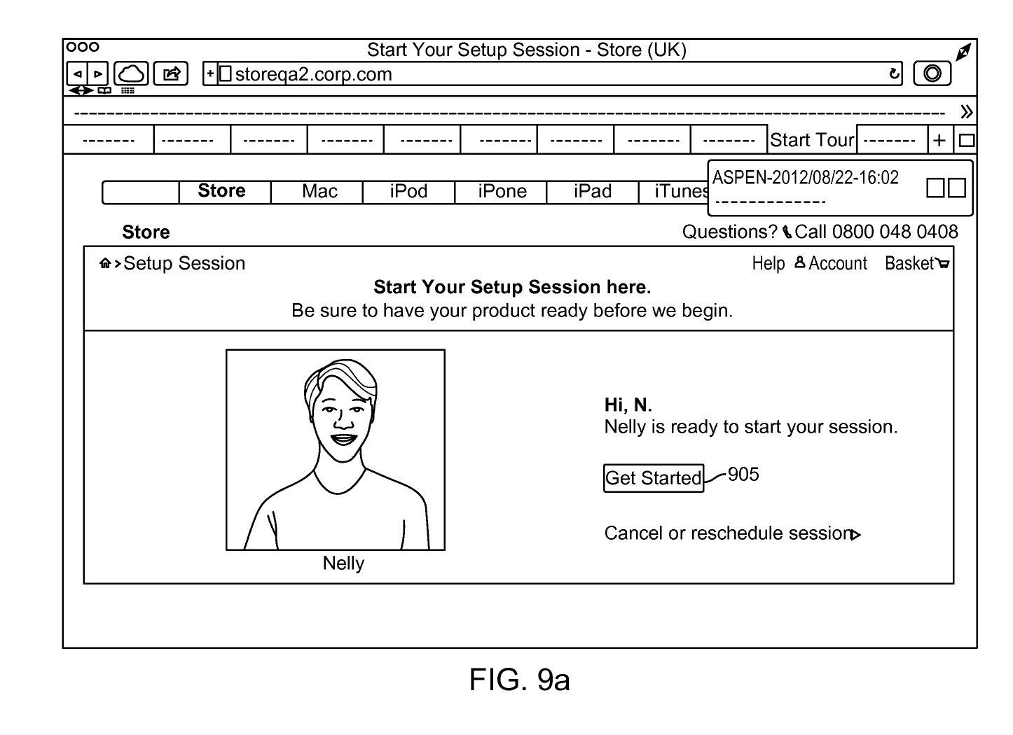

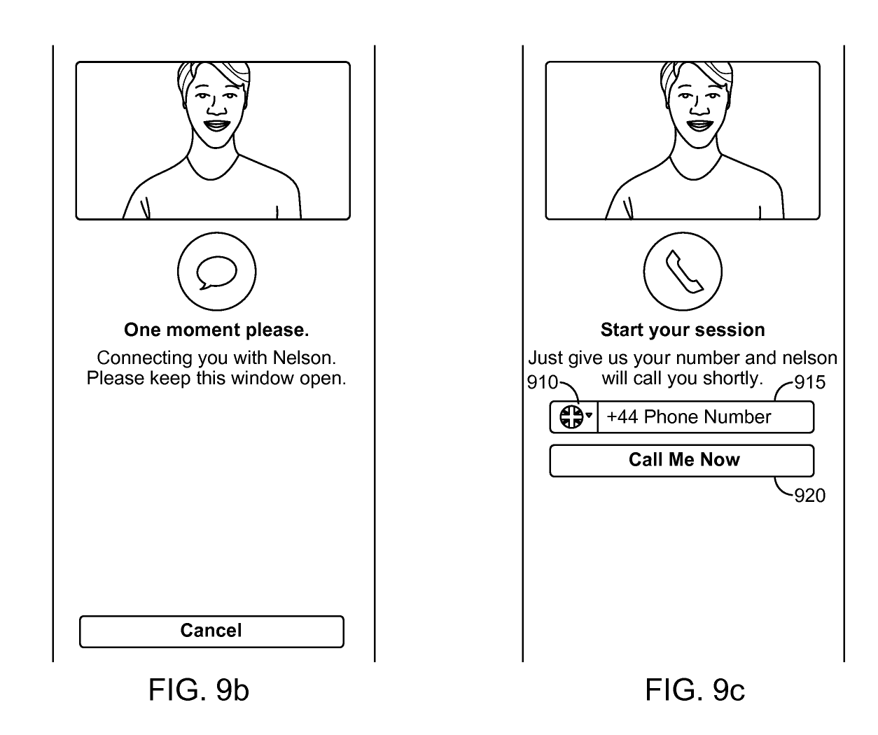

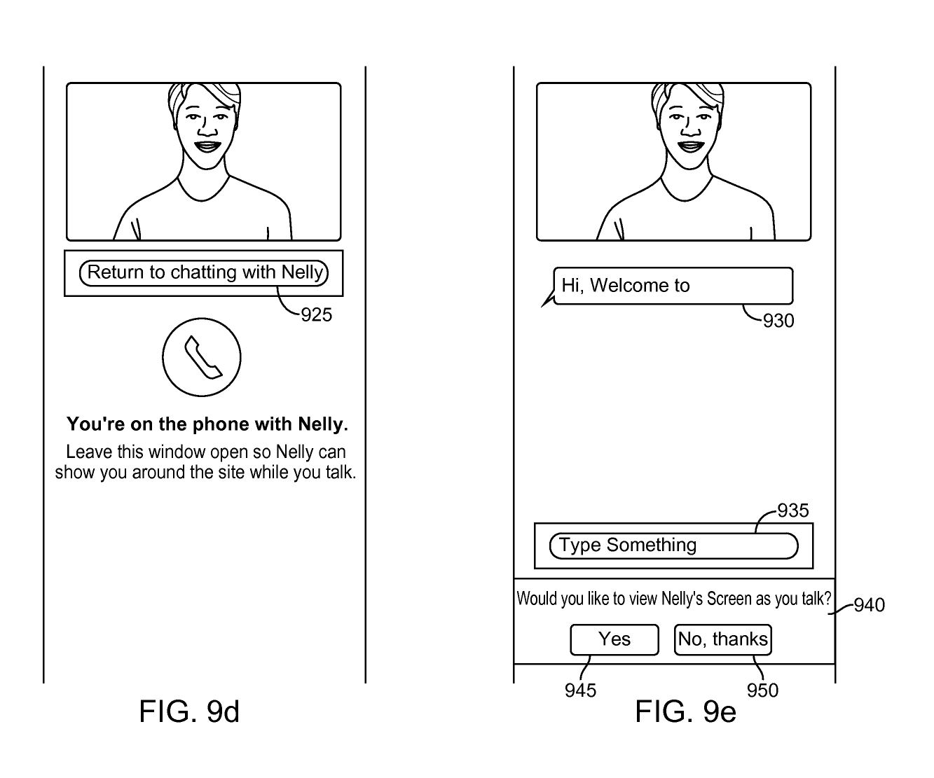

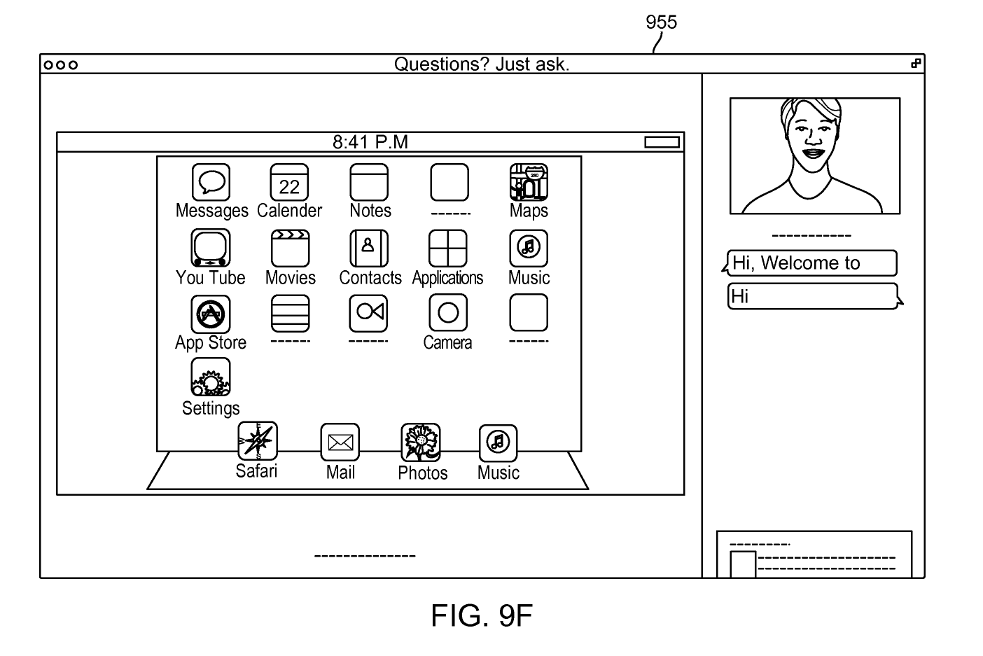

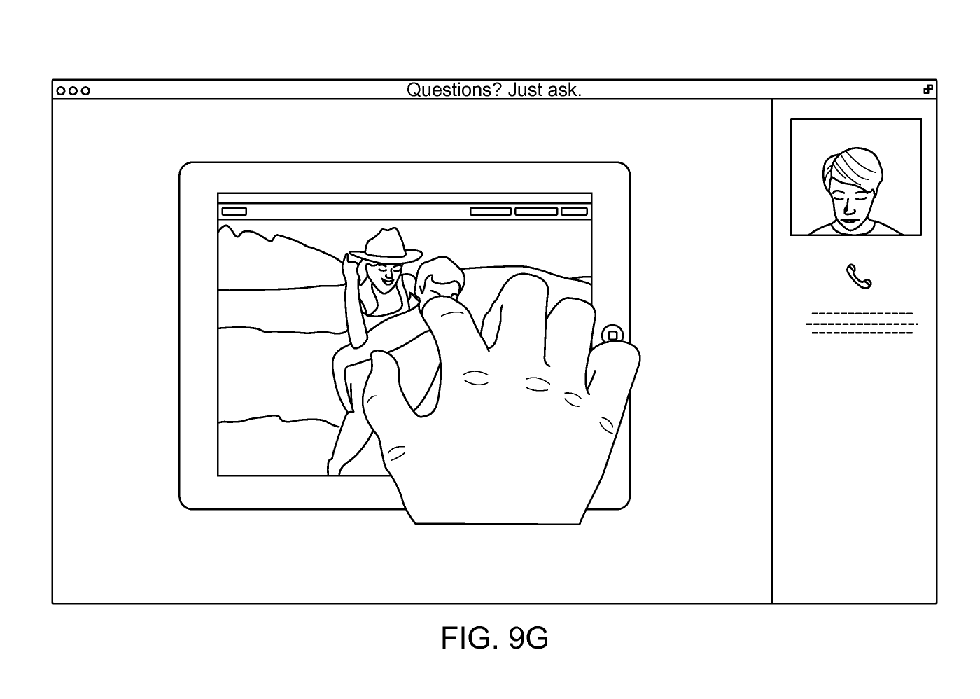

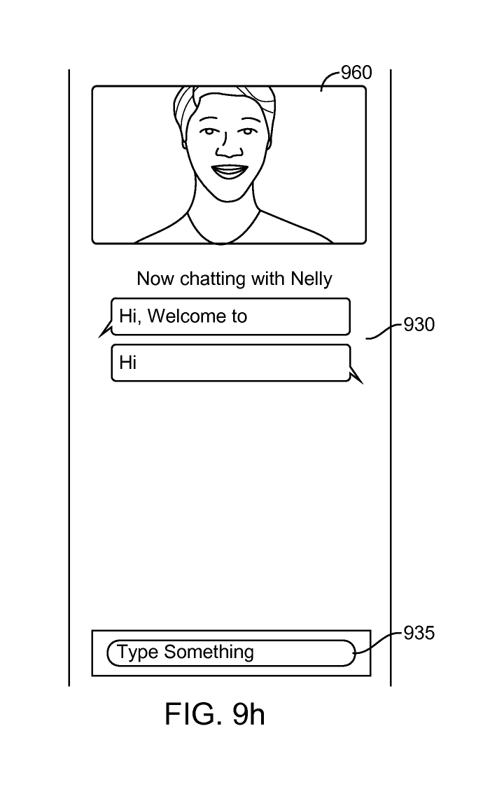

FIGS. 9a-9h illustrate screenshots of an exemplary communication session interface incorporating multiple communication methods. FIG. 9a illustrates a launch page similar to the one illustrated in FIG. 8b where a scheduled communication session is ready to be initiated. Upon selecting the provided button 905, a communication session interface such as the one illustrated in FIG. 9b can be presented to the user.

FIG. 9b illustrates an exemplary embodiment of an interface showing that the establishment of communication session is in progress. As illustrated, the communication session interface displays a picture of the remote agent and a message alerting the user that the communication session interface is connecting with the remote agent.

FIG. 9c illustrates the communication session interface initiating an initial communication method for the communication session. As illustrated, the user is prompted to enter their phone number to start the communication session with a phone communication, which will be the initial communication method. As illustrated, the communication session interface includes a country code selection box 910 that is configured to populate the country code in the phone number text field 915. The selected country is represented by a picture of the flag of the country. As illustrated, the selected country is the United Kingdom (UK) and the country code for the UK, 44, is entered into the phone number text field 915. The user can select the appropriate country for their phone number by selecting the country code selection box 910 and scrolling through available options to select the correct country. In some embodiments, the user can alternatively just enter their correct country code in the phone number text field 915 to change the country code.

In some embodiments, the initial country code set in the country code selection box 910 can be based on information known about the user. For example, a phone number associated with the user's profile can be used to determine the initial country code. Alternatively, a known address of the user can be used to select the first country code. In some embodiments, information gathered from the user computing device can be used to determine the initial country code. For example, the IP address associated with the user computing device can be used to determine the initial country code.

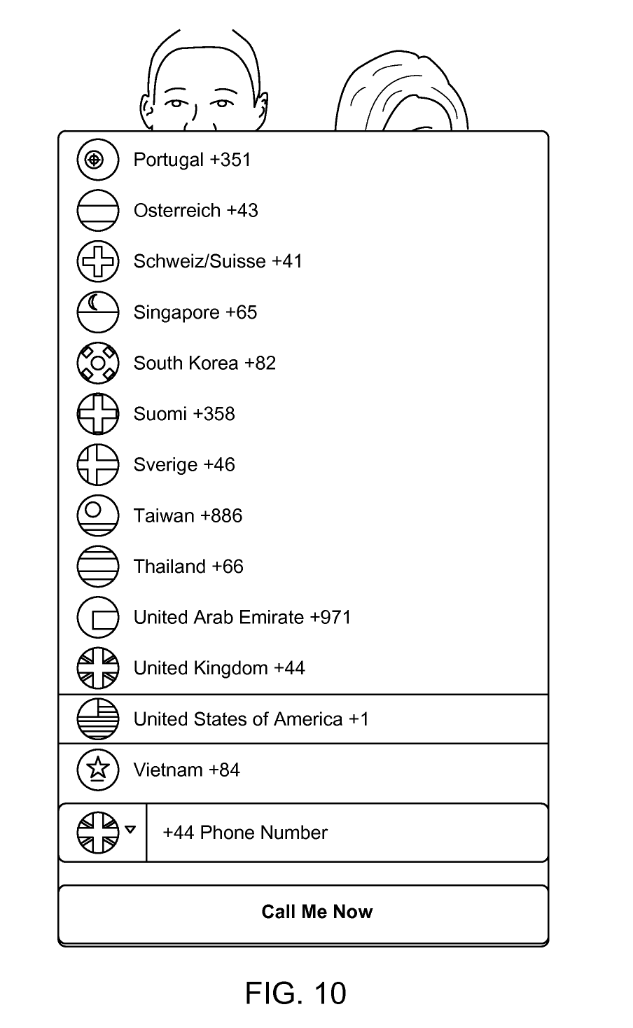

FIG. 10 illustrates a screenshot of one embodiment of a country code selection box presenting the multiple country options from which a user can select their appropriate country code. However, the various embodiments are not limited in this regard and selection of the country code can be performed in other ways than shown in FIG. 10.

Returning to the discussion of FIG. 9c, as illustrated, the communication session interface includes a button 920 configured to initiate the call. Upon selection of the button 920, a phone call can be placed to both the remote agent and the user. The user and the remote agent can then be connected to be speaking with each other.

FIG. 9d illustrates the communication session interface after a phone communication between the user and the remote agent has been connected. As illustrated, a message is displayed notifying the user that a phone communication with the remote agent has been connected. The communication session interface also includes a text field 925 enabling a user to initiate a chat communication with the remote agent. A user can enter text into the text field 925 and a chat communication with the user can be initiated. Thus the communication session interface enables a user to initiate a second communication method, chat, while the initial communication method, phone, is still in use. This can be beneficial for numerous reasons. For example, a URL, error message text, or the like, can be easily shared via the chat communication while long passages are easier to share via a phone communication. Thus having both communication methods available allows both the URL and long passages to be easily communicated.

FIG. 9e illustrates the communication session interface displaying a chat communication. As illustrated a chat display area 930 is presented where entered chat communications are displayed. The communication session interface further includes a text field 935 enabling a user to enter text to be communicated to the remote agent. Text entered in the text field 935 will be displayed in the chat display area 930 upon a user pressing enter.

In this embodiment, the user may also be communicating with the remote agent via another communication method such as phone. For example, this screenshot of the communication session interface can be the result of a user entering text in the text field of FIG. 9d.

Alternatively, this screenshot can be a first communication between the user and the remote agents. For example, this can be presented after the screenshot illustrated in FIG. 9b. Thus the initial communication method would be chat.

In addition to the text field 935 and chat display area 930, the illustrated communication session interface also includes a message inviting a user to view the remote agent's screen 940. In some embodiments, the communication session interface can always allow a user to view the remote agent's screen. In some embodiments, the communication session interface can be enabled to allow one party to invite the other party to view their screen, thus resulting in the message 940 being presented on the communication session interface presented to the other party.

In addition to the message 940, two user interface element buttons are also presented. One button 945 is configured to enable a user to accept the offer to view the remote agent's screen and the other button 950 is configured to enable a user to decline the invitation.

FIG. 9f illustrates a screenshot of the communication session interface where the remote agent's view is presented to the user. As illustrated, the remote agent's view 955 is presented in a second window. The screen 955 is presented in a direct view mode that depicts the screen output. Further, the chat communication is still displayed indicating that at least two communication methods, chat and screen share, are in use.

FIG. 9g illustrates a communication session interface where screen share communication is presented from an overhead view. As illustrated a tablet PC is illustrated from above so that the remote agent can be seen interacting with the tablet.

In addition to showing a user how to use a computing device, in some embodiments, screen share can be used to navigate a user through the purchasing process. For example, screen share can be used to show the user how to navigate through a store website. In this type of embodiments, the remote agent can guide a user through the website and answer questions as the user purchases items on the website. The overhead view of the screen share allows a remote agent to easily show the user how to navigate through the website.

FIG. 9h illustrates a communication session interface displaying a video communication. As illustrated, the top portion of the communication session interface is displaying a live video 960 of the remote agent. The bottom portion of the communication session interface is displaying the chat communication including the text field 935 and chat display area 930. In some embodiments, the video communication can include sound in addition to video. In some embodiments, the communication session can be using phone as a communication method for voice and video for only the video. Using both video and phone in this manner can lower bandwidth requirements and result in better performance because the network only needs to transmit video data rather than both video data and audio data.

FIGS. 11a-11d illustrate a screenshot of picture of a remote agent that is configured to present further information regarding the remote agents. As illustrated, in FIG. 11a, a picture 1105 of the remote agent is presented in a communication session interface. The picture 1105 includes a user interface element button 1110 configured to present further information upon selection. FIGS. 11b and 11c illustrate the picture 1105 of the remote agent rotating as a result of the user interface element 1110 being selected. The rotating picture 1105 reveals further information on the opposite side. FIG. 11d illustrates the picture 1105 completely rotated. As illustrated, further information about the remote agent is displayed on the back of the picture 1105. The back of the picture 1105 also includes the same user interface element 1110 as displayed in the front. The user interface element 1110 can be configured to cause the picture 1105 to rotate back to the front upon selection.

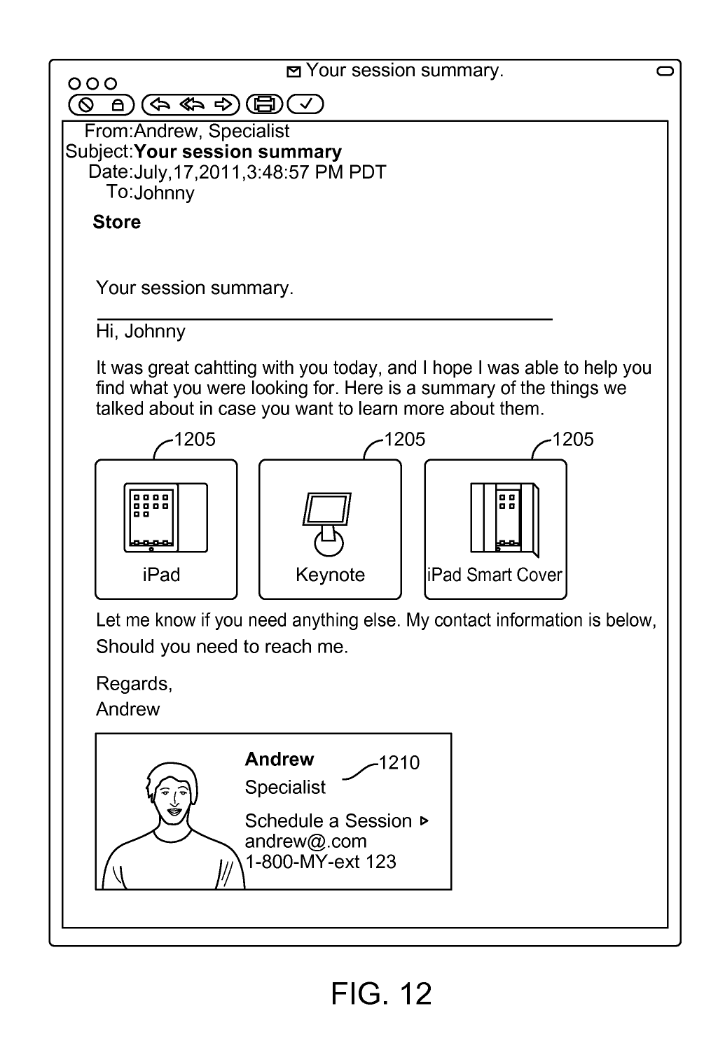

FIG. 12 illustrates an exemplary summary message. As illustrated, the summary message includes a message to the user as well as icons 1205 illustrating topics discussed during the communication session. In some embodiments, the icons 1205 can be active links that route the user to further information concerning the topic of the icon 1205. The summary message also includes a business card 1210 of the remote agent with which the communication session was conducted.

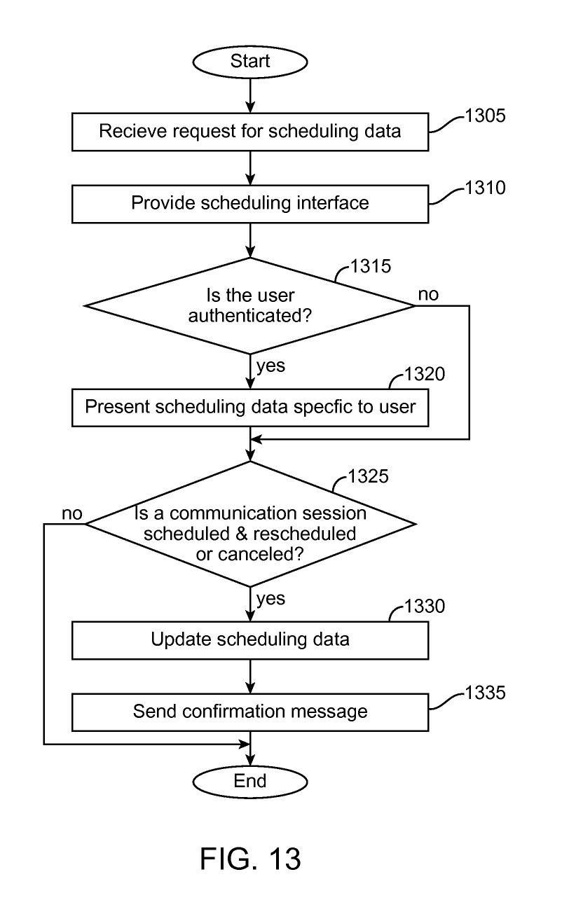

FIG. 13 illustrates an exemplary method embodiment of scheduling a communication session with a remote agent. As illustrated, the method begins at block 1305 when a request for scheduling data is received from a user. Scheduling data can be any data concerning scheduling a communication session as described above. The request can include a user requesting to view scheduling data such as information about available remote agents, available times, etc. In some embodiments, the request can be a user requesting the schedule, reschedule or cancel a communication session. For example, the request can be initiated by a link provided in a confirmation message sent to a user.

Upon receiving the request, the method continues to block 1310 where a scheduling interface is presented to the user. The scheduling interface can present scheduling data regarding the remote agents and their availability and enable a user to schedule a communication session.

The scheduling interface can further enable the user to enter login information to access scheduling data specific to the user. At step 1315 the method determines if the user is authenticated. For example, the method can determine if login information entered by the user matches records stored in a user profile database. If the user is authenticated, the method continues to block 1320 where scheduling data specific to the user is presented. This can include scheduling data about previous communication sessions as well as scheduling data about upcoming communication sessions.

At block 1325 the method determines whether a communication session has been scheduled, canceled or rescheduled. For example, a user can use user interface elements included in the scheduling interface to schedule, cancel or reschedule a communication session. If input indicating that a user has scheduled, rescheduled or canceled a communication session is received, the method continues to block 1330 where the scheduling data is updated to reflect the user's selection.

The method then continues to block 1325 where a confirmation message is sent to the user. The confirmation can confirm that the user's actions have been confirmed and that the scheduling data has been changed accordingly. For example, in response to a user scheduling a communication session, the user can be sent a confirmation message indicating that the communication session has been scheduled and further include the details of the communication session. The confirmation message can also include a link to a launch page configured to enable a user to enter the scheduled communication session. Upon sending the confirmation message, the method ends.

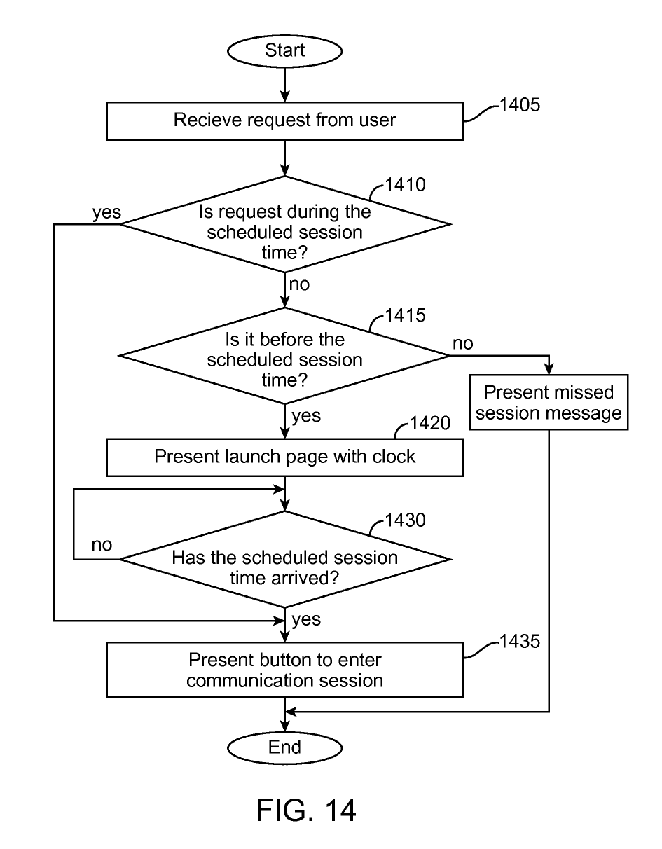

FIG. 14 illustrates an exemplary method embodiment of presenting a launch page to a user. As illustrated, the method begins at block 1405 where a request to receive the launch page is received from the user. For example the user can send the request by clicking a link included in a confirmation message or scheduling interface. Upon receiving the request, at block 1410 the method can determine whether it is during the scheduled time in which a use can enter the communication session. If it is during the time, the method can continue to block 1435 where the launch page is provided to the user with a button enabling the user to enter the communication session.

If at block 1410 it is determined that it is not during the scheduled time in which the user can enter the communication session, the method continues to block 1415 where it is determine whether it is prior to the scheduled time. If it is prior, the method continues to block 1420 where the launch page is presented with a clock counting down the remaining time until the user can enter the communication session. The button to enter the communication session is not provided.

The method then continues to block 1430 where it is determined whether the scheduled time has arrived. When the scheduled time has arrived, the method continues to block 1435 where the user is presented with the button enabling the user to enter the communication session. In some embodiments, the presented clock can be removed and the button can be presented in its place.

If at block 1415 is determined that it is not prior to the scheduled time, it can be determine that the user has missed the scheduled time. The method continues to block 1425 where a message indicating that the user has missed the scheduled time is presented to the user and then the method ends. In some embodiments the message can include a link enabling a user to reschedule the missed communication session.

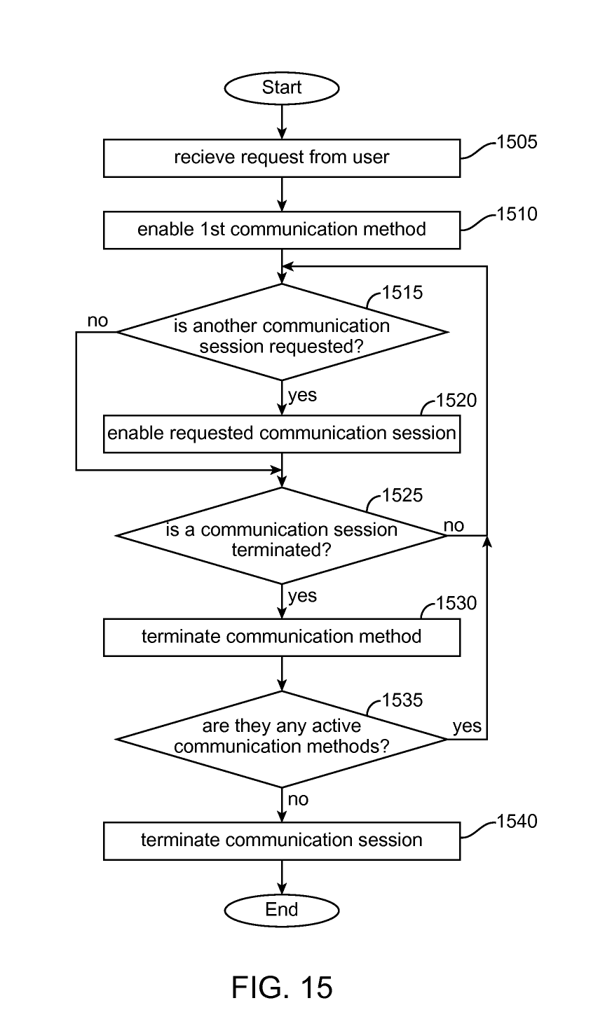

FIG. 15 illustrates an exemplary method embodiment of presenting a communication session to a user. As illustrated, the method begins at block 1505 where a request to enter a communication is received from the user. For example, the request can be initiated by a user selecting a button provided on a launch page. Upon receiving the request, the method continues to block 1510 where a first communication method is initiated in a communication session interface. For example, the first communication method can be chat communication.

The method then continues to block 1515 where it is determined whether a secondary communication method is requested by a user or remote agent. In some embodiments, a user can select a user interface element presented in the communication session that enables the user to request that a secondary communication method be initiated. For example, the user can select a button to initiate a screen share communication.

Upon receiving the request, the method continues to block 1520 where the secondary communication method is enabled within the communication session interface.

The method then continues to block 1525 where it is determined if the user wishes to terminate an active communication method. For example, a user can terminate a communication session by selecting a button or providing some other input. If it is determined that the user does want to terminate an active communication method, the method continues to block 1530 where the communication method is terminated. If the user does not want to terminate an active communication method, the method returns to block 1515.

Upon terminating an active communication method, the method continues to block 1535 where it is determined whether any communications remain active. If no communication methods are active, the method continues to block 1540 where the communication session is terminated and the method ends. If there is at least one communication method that remains active, the method continues to block 1515.

The present disclosure recognizes that the use of such personal information data in the present technology can be used to the benefit of users. For example, the personal information data can be used to better understand user behavior, facilitate and measure the effectiveness of advertisements, applications, and delivered content. Accordingly, use of such personal information data enables calculated control of the delivered content. For example, the system can reduce the number of times a user receives a given ad or other content and can thereby select and deliver content that is more meaningful to users. Such changes in system behavior improve the user experience. Further, other uses for personal information data that benefit the user are also contemplated by the present disclosure.

The present disclosure further contemplates that the entities responsible for the collection, analysis, disclosure, transfer, storage, or other use of such personal information data should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after the informed consent of the users. Additionally, such entities would take any needed steps for safeguarding and securing access to such personal information data and ensuring that others with access to the personal information data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for advertisement delivery services. In yet another example, users can configure their devices or user terminals to prevent storage or use of cookies and other mechanisms from which personal information data can be discerned. The present disclosure also contemplates that other methods or technologies may exist for blocking access to their personal information data.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method comprising:
initiating, by a processor, a communication session enabled with a primary communication method selected from a plurality of communication methods, wherein the communication session is a communication between a user and a remote agent;
upon receiving a first input identifying an additional communication method from the plurality of communication methods to be added to the communication session, enabling the additional communication method identified by the first input, wherein further communication methods can be added to the communication session; and
upon receiving a second input identifying one of the enabled communication methods to terminate from the communication session, terminating the communication method identified by the second input, wherein the communication session remains active as long as one communication method remains enabled.

2. The method of claim 1, wherein the plurality of communication methods consists of text, video, audio, phone and screen share.

3. The method of claim 2, wherein screen share is an overhead view of a computing device being physically controlled by a remote agent.

4. The method of claim 1, further comprising:
upon the communication session ending, sending a summary message to the user, the summary message comprising links to content relevant to the communication session.

5. The method of claim 4, wherein the links are selected based upon input received from the remote agent.

6. The method of claim 2, further comprising:
when the first input identifies phone to be added to the communication session, prompting the user to enter their telephone number.

7. The method of claim 6, further comprising:
populating a portion of the user's telephone number based upon a determined location of the user.

8. The method of claim 6, further comprising:
initiating a phone call to both the remote agent and the phone number provided by the user, wherein the remote agent is connected to the phone number provided by the user.

9. The method of claim 1, wherein the first input is text being entered into a text field and the additional communication method identified by the first input is text.

10. A system comprising:
a processor; and
a memory containing instructions that, when executed, cause the processor to:
initiate a communication session enabled with a primary communication method selected from a plurality of communication methods, wherein the communication session is a communication between a user and a remote agent;
upon receiving a first input identifying an additional communication method from the plurality of communication methods to be added to the communication session, enable the additional communication method identified by the first input, wherein further communication methods can be added to the communication session; and
upon receiving a second input identifying one of the enabled communication methods to terminate from the communication session, terminate the communication method identified by the second input, wherein the communication session remains active as long as one communication method remains enabled.

11. The system of claim 10, wherein the plurality of communication methods consists of text, video, audio, phone and screen share.

12. The system of claim 11, wherein screen share is an overhead view of a computing device being physically controlled by a remote agent.

13. The system of claim 10, wherein the instructions further cause the processor to:
upon the communication session ending, send a summary message to the user, the summary message comprising links to content relevant to the communication session.

14. The system of claim 13, wherein the links are selected based upon input received from the remote agent.

15. The system of claim 11, wherein the instructions further cause the processor to:
when the first input identifies phone to be added to the communication session, prompt the user to enter their telephone number.

16. The system of claim 15, wherein the instructions further cause the processor to:
populating a portion of the user's telephone number based upon a determined location of the user.

17. The system of claim 15, wherein the instructions further cause the processor to:
initiate a phone call to both the remote agent and the phone number provided by the user, wherein the remote agent is connected to the phone number provided by the user.

18. The system of claim 10, wherein the first input is text being entered into a text field and the additional communication method identified by the first input is text.

19. A non-transitory computer-readable medium containing instructions that, when executed, cause a computing device to:
initiate a communication session enabled with a primary communication method selected from a plurality of communication methods, wherein the communication session is a communication between a user and a remote agent;
upon receiving a first input identifying an additional communication method from the plurality of communication methods to be added to the communication session, enabling the additional communication method identified by the first input, wherein further communication methods can be added to the communication session; and
upon receiving a second input identifying one of the enabled communication methods to terminate from the communication session, terminating the communication method identified by the second input, wherein the communication session remains active as long as one communication method remains enabled.

20. The non-transitory computer-readable medium of claim 19, wherein the plurality of communication methods consists of text, video, audio, phone and screen share.

21. The non-transitory computer-readable medium of claim 20, wherein screen share is an overhead view of a computing device being physically controlled by a remote agent.

22. The non-transitory computer-readable medium of claim 19, wherein the instructions further cause the computing device to:
upon the communication session ending, send a summary message to the user, the summary message comprising links to content relevant to the communication session.

23. The non-transitory computer-readable medium of claim 22, wherein the links are selected based upon input received from the remote agent.

24. The non-transitory computer-readable medium of claim 20, wherein the instructions further cause the computing device to:
when the first input identifies phone to be added to the communication session, prompt the user to enter their telephone number.

25. The non-transitory computer-readable medium of claim 24, wherein the instructions further cause the computing device to:
populate a portion of the user's telephone number based upon a determined location of the user.

26. The non-transitory computer-readable medium of claim 24, wherein the instructions further cause the computing device to:
initiate a phone call to both the remote agent and the phone number provided by the user, wherein the remote agent is connected to the phone number provided by the user.

27. The non-transitory computer-readable medium of claim 19, wherein the first input is text being entered into a text field and the additional communication method identified by the first input is text.
